(19) United States
(12) Patent Application Publication
(10) Pub. No.: US 2023/0396348 A1
(43) Pub. Date: Dec. 7, 2023

(54) RADIO ENVIRONMENT EVALUATION METHOD AND WIRELESS COMMUNICATION CHARACTERISTIC EVALUATION SYSTEM

(71) Applicant: Hitachi, Ltd., Tokyo (JP)

(72) Inventors: Ken TAKEI, Tokyo (JP); Masami OHNISHI, Tokyo (JP); Ryosuke FUJIWARA, Tokyo (JP)

(21) Appl. No.: 18/201,227

(22) Filed: May 24, 2023

(30) Foreign Application Priority Data
Jun. 6, 2022 (JP) 2022-091921

(51) Int. Cl. H04B 17/391; H04W 24/06

(52) U.S. Cl. CPC H04B 17/3912; H04W 24/06

(57) ABSTRACT

An objective of the present invention is to use a calculation model to calculate, with good accuracy, behavior of electromagnetic waves within an actual service area. Provided is a radio environment evaluation method that includes constructing, within a computer resource, a structural model for an electromagnetic wave scatterer, and when calculating a characteristic of an electromagnetic field by using the structural model and a ray that simulates a radio wave traveling straight through real space, correcting, in accordance with electromagnetic wave vector measurement data for real space, a state of a polygon included in the structural model.

### CROSS-REFERENCE TO RELATED APPLICATION

The present application claims priority from Japanese application JP2022-091921, filed on Jun. 6, 2022, the content of which is hereby incorporated by reference into this application.

### BACKGROUND OF THE INVENTION

### 1. Field of the Invention

The present invention pertains to a radio communication system that transmits information by using electromagnetic waves in a radio wave environment in which a radio wave scatterer is present in a service area. In particular, the present invention pertains to a wireless communication characteristic evaluation technique that virtually reproduces a wireless communication state within a service area in accordance with electromagnetic field measurement of a service area, radio wave environment within the area, and numerical analysis of communication performance using a computer resource.

### 2. Description of the Related Art

Due to the spread of portable wireless information terminals across the whole world, there are increasing requests desiring the enjoyment of stable wireless communication services, such as wireless calls and wireless data transfers, irrespective of the surrounding environment. When a radio wave scatterer is present within an area in which a wireless communication service is provided, electromagnetic waves in a wireless communication medium undergo scattering due to the scatterer, power fluctuations arise when an electromagnetic wave radiated from a transmitter reaches a receiver, a decrease in reception power is caused in many cases, and a region where good-quality wireless communication is difficult is formed within the area.

In addition, in a case where the relative position and orientation between the scatterer and the communicating transceiver dynamically change, even within an area where good-quality wireless communication is possible, there are cases where signal strength achieved by a receiver fluctuates over time and deterioration of communication quality is caused, or a time of being unable to communicate occurs.

The formation of such regions and the occurrence of such times is determined by the arrangement relationship of electromagnetic wave scatterers and the positional relationship and respective orientation of transceivers that wirelessly communicate, within the service area. Accordingly, in a case of forming a wireless communication network within a service area, predicting communication statuses relating to the arrangement state of various transceivers is very important for the formation of the wireless communication network.

In order to know the communication status with respect to specific arrangement of transceivers within a service area, it is necessary to actually arrange transceivers within the service area and measure a characteristic for received electromagnetic waves. However, because wireless communication is strongly impacted by electromagnetic wave scatterers that confine transmission and reception, there can be cases where there needs to be measures for prohibiting entrance into an area to be measured in order to minimize variable factors during measurement, and, in the first place, great costs are incurred for securing and dispatching personnel in order to perform communication experiments as well as ensuring there is time for experiments.

In order to resolve these problems, techniques for constructing, within a computer, an electromagnetic field calculation model for analyzing a wireless communication characteristic within a service area and virtually realizing an electromagnetic field distribution pertaining to every possible arrangement state for transceivers within the area have been proposed. In order to construct an electromagnetic field calculation model within a computer resource, it is necessary to construct, within the computer resource, a structural model for an electromagnetic wave scatterer that is present within the wireless communication service area and impacts electromagnetic waves.

It is in principle possible to obtain data pertaining to structures within a service area from, inter area, design data for buildings and catalog specifications for furniture, fixtures, and appliances present within the area, but such design data is in many cases typically not published and is very difficult to obtain. Even if catalog specifications for furniture, fixtures, and appliances are explicit, identifying how the furniture, fixtures, and appliances are arranged within the service area is typically not easy. In order to solve this problem, there is often use of point cloud measurement system that use a measuring system that is referred to as light detection and ranging (LIDAR) and uses light waves such as visible light or infrared light.

LIDAR emits light waves three-dimensionally from a single point within the service area, detects scattered light waves that have been reflected and return, and uses the phase delay thereof to measure three-dimensional coordinates of a point that caused reflection, in accordance with the direction and distance from this single point. A set of three-dimensional coordinate points obtained using LIDAR is referred to as a point cloud, and attempts are made to obtain structures within the service area using this point cloud. The point cloud is a grouping of representative points for the surface of structures within the service area, and a technique for reproducing the original structures from the point cloud is necessary.

With conventional techniques, an original structure is reproduced as an aggregate of planar elements referred to as polygons, which join a plurality of nearby points within the point cloud. However, there is a very high degree of freedom in selecting nearby points for forming a polygon, and there is error in the coordinates themselves of the points forming a point cloud due to errors in point cloud measurement using LIDAR. Therefore, a model of a structure reproduced from these polygons typically imparts, on electromagnetic waves used in wireless communication, a scattering phenomenon different to that for an actual structure. Accordingly, it must be said that it is at present very difficult to obtain an electromagnetic field calculation model for a structure within a service area in accordance with only point cloud data obtained by LIDAR.

Techniques that use a physical quantity that can be measured within a service area to correct a model for electromagnetic field calculation represented by polygons created using point cloud data obtained using LIDAR, and improve a result of calculating an electromagnetic field using a calculation model that is within a computer resource and reproduces the wireless communication environment within the service area have been proposed.

WO2012/172670 A1 sets forth a technique that uses an electromagnetic wave measurement value measured at a location within a service area and a calculation model for electromagnetic field calculations in order to cause structure information for a portion of the calculation model impacting a calculated value for the electromagnetic field at the location to change and thereby make the calculated value approach the electromagnetic field measurement value for the same location.

In addition, WO2008/099927 A1 sets forth a technique that selectively removes elements having little impact on a radio wave radiated from a transmission point, from among a plurality of planar elements configuring an object within an analysis region used by a system for estimating a radio wave propagation characteristic, and corrects a calculation model to thereby improve the calculation accuracy for an electromagnetic field calculation.

### SUMMARY OF THE INVENTION

The cited techniques both pay attention to the nature of a radio wave traveling straight in free space, and form a calculation model in a computer resource by envisioning a process in which, when a radio wave that travels straight has collided with an obstacle, the radio wave undergoes a change to the direction for traveling straight and power, and the travels straight in free space again. This is a method in which the calculation model is used to estimate the path on which the radio wave travels, estimate a portion within the calculation model that the radio wave should collide with, and apply a change to this portion to thereby align the characteristics of an electromagnetic wave calculated in the computer resource with the characteristics of an electromagnetic wave measured at a corresponding location within an actual service area.

However, the cited techniques have no guarantee of being able to faithfully reproduce, in a computer resource, the process by which a radio wave travels within an actual service area. Therefore, there is a problem that it is not necessarily the case that a calculation model to which a change using a measurement value has been added can accurately calculate behavior for an electromagnetic wave within an actual service area.

An objective of the present invention is to use a calculation model to calculate, with good accuracy, behavior of electromagnetic waves within an actual service area.

One desirable aspect of the present invention is a radio environment evaluation method that includes constructing, within a computer resource, a structural model for an electromagnetic wave scatterer, and when calculating a characteristic of an electromagnetic field by using the structural model and a ray that simulates a radio wave traveling straight through real space, correcting, in accordance with electromagnetic wave vector measurement data for real space, a state of a polygon included in the structural model.

Another desirable aspect of the present invention is a wireless communication characteristic evaluation system provided with: a model generation unit; an electric field calculation unit; and a polygon correction unit, the model generation unit constructing, in a computer resource, a structural model for an electromagnetic wave scatterer present in real space, the electric field calculation unit using the structural model to perform a ray-tracing calculation, estimating an electric field strength within real space, and calculating an estimated electric field strength, and the polygon correction unit, on the basis of a direction of arrival of an electromagnetic wave measured within real space, identifying and correcting a polygon needing correction from among polygons included in the structural model.

It is possible to use a calculation model to calculate, with good accuracy, behavior of electromagnetic waves within an actual service area.

### BRIEF DESCRIPTION OF THE DRAWINGS

FIG. 1A is a perspective view that illustrates a configuration of a wireless communication performance evaluation system according to an embodiment;

FIG. 1B is a perspective view of a service area for a wireless communication system according to an embodiment;

FIG. 1C is a conceptual diagram that illustrates measurement points in a computer resource for a wireless communication system according to an embodiment;

FIG. 1D is a conceptual diagram that illustrates an electromagnetic field calculation model in a computer resource in a wireless communication system according to an embodiment;

FIG. 2 is an explanatory view that illustrates an electromagnetic field calculation model in a computer resource in a wireless communication system according to an embodiment;

FIG. 3 is an explanatory view for illustrating an operating principle for an electromagnetic field calculation model in a computer resource in a wireless communication system according to an embodiment;

FIG. 4 is an explanatory view for illustrating an operating principle of a wireless communication performance evaluation system according to an embodiment;

FIG. 5A is a block view of a wireless communication performance evaluation system according to an embodiment;

FIG. 5B is a flow chart for describing operation by a wireless communication performance evaluation system according to an embodiment;

FIG. 6A is a transparent perspective view that illustrates a structure of an incoming-wave-direction measurement device used by a wireless communication performance evaluation system according to an embodiment;

FIG. 6B is a circuit diagram of the incoming-wave-direction measurement device used by the wireless communication performance evaluation system according to an embodiment;

FIG. 7 is another circuit diagram of the incoming-wave-direction measurement device used by the wireless communication performance evaluation system according to an embodiment;

FIG. 8 is another circuit diagram of the incoming-wave-direction measurement device used by the wireless communication performance evaluation system according to an embodiment;

FIG. 9 is another circuit diagram of the incoming-wave-direction measurement device used by the wireless communication performance evaluation system according to an embodiment;

FIG. 10 is another circuit diagram of the incoming-wave-direction measurement device used by the wireless communication performance evaluation system according to an embodiment;

FIG. 11 is another circuit diagram of the incoming-wave-direction measurement device used by the wireless communication performance evaluation system according to an embodiment;

FIG. 12 is another circuit diagram of the incoming-wave-direction measurement device used by the wireless communication performance evaluation system according to an embodiment;

FIG. 13 is another circuit diagram of the incoming-wave-direction measurement device used by the wireless communication performance evaluation system according to an embodiment;

FIG. 14 is another circuit diagram of the incoming-wave-direction measurement device used by the wireless communication performance evaluation system according to an embodiment;

FIG. 15 is another circuit diagram of the incoming-wave-direction measurement device used by the wireless communication performance evaluation system according to an embodiment;

FIG. 16 is another circuit diagram of the incoming-wave-direction measurement device used by the wireless communication performance evaluation system according to an embodiment;

FIG. 17A is a transparent perspective view that illustrates an example of another structure of the incoming-wave-direction measurement device used by a wireless communication performance evaluation system according to an embodiment;

FIG. 17B is an explanatory view that illustrates a geometric arrangement of another structure of the incoming-wave-direction measurement device used by a wireless communication performance evaluation system according to an embodiment;

FIG. 18A is a transparent perspective view that illustrates an example of another structure of the incoming-wave-direction measurement device used by a wireless communication performance evaluation system according to an embodiment;

FIG. 18B is an explanatory view that illustrates a geometric arrangement of another structure of the incoming-wave-direction measurement device used by a wireless communication performance evaluation system according to an embodiment;

FIG. 19A is an explanatory view that illustrates a geometric arrangement of another structure of the incoming-wave-direction measurement device used by a wireless communication performance evaluation system according to an embodiment;

FIG. 19B is an explanatory view that illustrates a geometric arrangement of another structure of the incoming-wave-direction measurement device used by a wireless communication performance evaluation system according to an embodiment;

FIG. 20 is a conceptual diagram that illustrates an example of an environment-adaptive wireless communication system used by a wireless communication performance evaluation system according to an embodiment; and

FIG. 21 is a conceptual diagram that illustrates an example of another environment-adaptive wireless communication system used by a wireless communication performance evaluation system according to an embodiment.

### DESCRIPTION OF THE PREFERRED EMBODIMENTS

Using the drawings, description is given regarding embodiments below. However, the present invention should not be interpreted as limited to the content set forth in the embodiments described below. It will be readily understood by a person skilled in the art that specific configurations thereof can be modified in a scope that does not deviate from the concept or spirit of the present invention.

In configurations of embodiments described below, there are cases where the same reference symbols are commonly used across different drawings for the same portions or portions having similarly functionality, and duplicate descriptions are omitted.

In a case where there is a plurality of elements having the same or similar functionality, there are cases where description is given after adding a different suffix to the same reference symbol. However, there are cases where description is given while omitting suffixes if there is no need to distinguish the plurality of elements.

Language such as “first,” “second,” and “third” in the present specification or the like is added in order to identity components, and there is not necessarily a limitation to the number, order, or content thereof. In addition, numbers for identifying components are used for each context, and there is no limitation to a number used in one context necessarily indicating the same configuration in another context. In addition, a component identified by a certain number is not obstructed from also having functionality for a component identified by another number.

Positions, sizes, shapes, ranges, and the like for each configuration illustrated in the drawings, etc. are in order to facilitate understanding of the invention, and in some cases do not represent actual positions, sizes, shapes, ranges, and the like. Accordingly, the present invention is not necessarily limited to positions, sizes, shapes, ranges, and the like disclosed in the drawings, etc.

Publications, patents, and patent applications cited in the present specification form, unchanged, a portion of the description of the present specification.

Components expressed in the singular in the present specification include the plural unless the singular is explicitly indicated in a particular context.

The embodiments include a plurality of means for resolving the abovementioned problems, but if one example thereof is given, a set (point cloud) of points is obtained by a device that, using light waves at a plurality of locations within a wireless communication service area, measures the distance and direction to each point on a structure present within the area from these locations, the point cloud is represented by coordinates in a computer resource, a polygon having as vertexes three or more proximate points in the point cloud is formed in the computer resource, a transmitter is installed within this service area, the intensity of an electromagnetic wave transmitted from the transmitter is measured at the plurality of locations within the service area, and a transmitter is installed at corresponding locations in the computer resource and a radio wave that travels straight is radiated in a plurality of three-dimensional directions from the transmitter. In a case where the plurality of radio waves have collided with the polygon, properties related to the direction, intensity, and phase of the radio waves are caused to change sequentially, an electromagnetic wave at the locations where the measurement is performed is calculated, a comparison is made between a measurement value for real space (the space in reality) and the calculated value in the computer resource, and the normal direction of the polygon is changed such that the measurement value and the calculated value become closer to thereby estimate an electromagnetic field distribution within the service area.

In addition, if another example is given, a set (point cloud) of points is obtained by a device that, using light waves at a plurality of locations within a wireless communication service area, measures the distance and direction to each point on a structure present within the area from these locations, the point cloud is represented by coordinates in a computer resource, a polygon having as vertexes three or more proximate points in the point cloud is formed in the computer resource, a transmitter is installed within this service area, the intensity of an electromagnetic wave transmitted from the transmitter is measured at the plurality of locations within the service area, and a transmitter is installed at corresponding locations in the computer resource and a radio wave that travels straight is radiated in a plurality of three-dimensional directions from the transmitter. In a case where the plurality of radio waves have collided with the polygon, properties related to the direction, intensity, and phase of the radio waves are caused to change sequentially, an electromagnetic wave at the locations where the measurement is performed is calculated, a comparison is made between a measurement value for real space and the calculated value in the computer resource, and the position of a point in the point cloud configuring the polygon is changed such that the measurement value and the calculated value become closer to thereby estimate an electromagnetic field distribution within the service area.

In addition, if another example is given, a set (point cloud) of points is obtained by a device that, using light waves at a plurality of locations within a wireless communication service area, measures the distance and direction to each point on a structure present within the area from these locations, the point cloud is represented by coordinates in a computer resource, a polygon having as vertexes three or more proximate points in the point cloud is formed in the computer resource, a transmitter is installed within this service area, the intensity and incoming-wave direction for an electromagnetic wave transmitted from the transmitter are measured at the plurality of locations within the service area, and a transmitter is installed at corresponding locations in the computer resource and a radio wave that travels straight is radiated in a plurality of three-dimensional directions from the transmitter. In a case where the plurality of radio waves have collided with the polygon, properties related to the direction, intensity, and phase of the radio waves are caused to change sequentially, an electromagnetic wave at the locations where the measurement is performed is calculated, a comparison is made between a measurement value for real space and the calculated value in the computer resource, and the position of a point in the point cloud configuring the polygon in the computational resource present in an incoming-wave direction measured from the position in the computer resource corresponding to the location where the intensity and incoming-wave direction for an electromagnetic wave is measured in the service area is changed such that the measurement value and the calculated value become closer to thereby estimate an electromagnetic field distribution within the service area.

In addition, if another example is given, a set (point cloud) of points is obtained by a device that, using light waves at a plurality of locations within a wireless communication service area, measures the distance and direction to each point on a structure present within the area from these locations, the point cloud is represented by coordinates in a computer resource, a polygon having as vertexes three or more proximate points in the point cloud is formed in the computer resource, a transmitter is installed within this service area, the intensity for an electromagnetic wave transmitted from the transmitter is measured, the direction of an incoming wave is also estimated at a plurality of locations within the service area by spatially distributing a plurality of antennas near the same locations and using the relative positions of the plurality of antennas and a plurality of relative phases obtained by measuring the phase of an incoming wave received by the antennas as a relative phase with respect to one reference phase, and a transmitter is installed at corresponding locations in the computer resource and a radio wave that travels straight is radiated in a plurality of three-dimensional directions from the transmitter. In a case where the plurality of radio waves have collided with the polygon, properties related to the direction, intensity, and phase of the radio waves are caused to change sequentially, an electromagnetic wave at the locations where the measurement is performed is calculated, a comparison is made between a measurement value for real space and the calculated value in the computer resource, and the position of a point in the point cloud configuring the polygon in the computational resource present in an incoming-wave direction measured from the position in the computer resource corresponding to the location where the intensity and incoming-wave direction for an electromagnetic wave is measured in the service area is changed such that the measurement value and the calculated value become closer to thereby estimate an electromagnetic field distribution within the service area.

In addition, if another example thereof is given, a set (point cloud) of points is obtained by a device that, using light waves at a plurality of locations within a wireless communication service area, measures the distance and direction to each point on a structure present within the area from these locations, the point cloud is represented by coordinates in a computer resource, a polygon having as vertexes three or more proximate points in the point cloud is formed in the computer resource, a transmitter is installed within this service area, the intensity for an electromagnetic wave transmitted from the transmitter is measured, the direction of an incoming wave is also estimated at a plurality of locations within the service area by spatially distributing a plurality of antenna pairs, which are spatially orthogonal to each other, near the same locations and using the relative positions of the plurality of antenna pairs and a plurality of relative phases obtained by measuring the phase of an incoming wave received by the antenna pairs as a relative phase with respect to one reference phase while a polarization direction for the incoming wave is estimated using a ratio for reception amplitudes for the two antennas forming each antenna pair, and a transmitter is installed at corresponding locations in the computer resource and a radio wave that travels straight is radiated in a plurality of three-dimensional directions from the transmitter. In a case where the plurality of radio waves have collided with the polygon, properties related to the direction, intensity, and phase of the radio waves are caused to change sequentially, an electromagnetic wave at the locations where the measurement is performed is calculated, a comparison is made between a measurement value for real space and the calculated value in the computer resource, and the position of a point in the point cloud configuring the polygon in the computational resource present in an incoming-wave direction measured from the position in the computer resource corresponding to the location where the intensity and incoming-wave direction for an electromagnetic wave is measured inside the service area is changed such that the measurement value and the calculated value become closer to thereby estimate an electromagnetic field distribution within the service area.

### [First Embodiment]

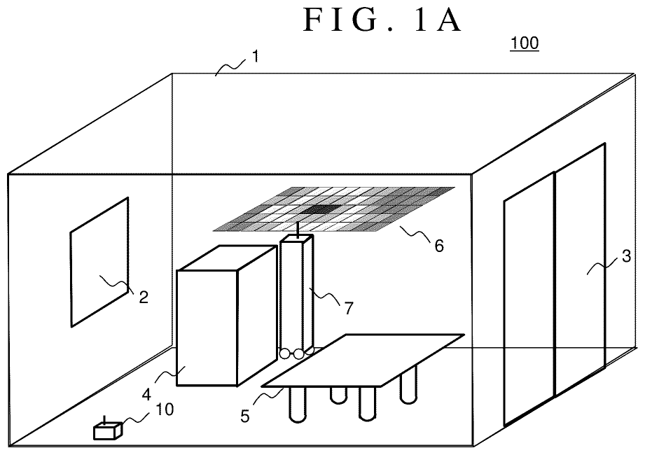

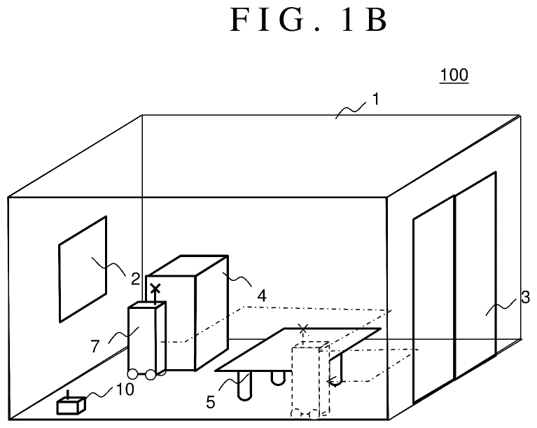

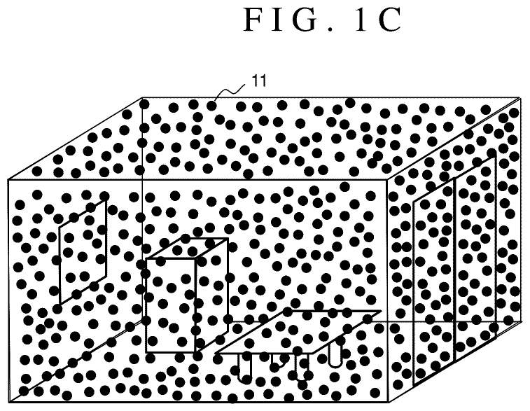

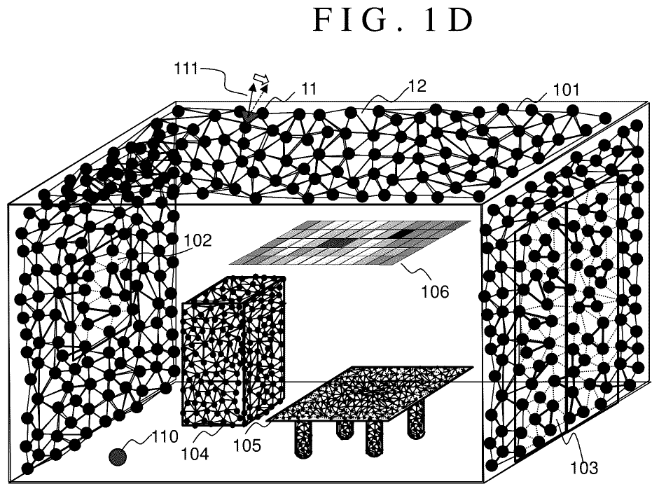

FIG. 1A through 1D are used to describe an embodiment of a wireless communication performance evaluation system that improves the accuracy of a communication performance prediction for a wireless communication system, and reduces the cost of introducing the same system.

FIG. 1A is a perspective view for describing a configuration in real space for the wireless communication performance evaluation system.

FIG. 1B is a perspective view for describing a procedure in real space for the same wireless communication performance evaluation system to obtain, in a computer resource, position data for structures present in a wireless communication service area.

FIG. 1C is a conceptual diagram for describing a procedure for, using the obtained position data for the structures, generating an electromagnetic field calculation model (may be simply referred to as a calculation model) for performing an electromagnetic field calculation within the computer resource.

FIG. 1D is a conceptual diagram of a structural model that is generated in order to performing an electromagnetic field calculation within a computer resource, using the obtained position data for the structure.

In an example of a wireless communication performance evaluation system 100 in FIG. 1A, a room 1 that is surrounded by a ceiling, floor, and walls is an area (indoor space) in which a wireless communication service is carried out, a window 2 and a door 3 are provided in the walls, and shelves 4 and a table 5 are disposed within the same area. A movable radio wave measurement device 7 measures a radio wave intensity at a limited space inside the room 1 as well as a radio wave arrival direction at various locations within the space, the radio wave intensity and the radio wave arrival directions being generated due to transmission waves from a transceiver 10. The movable radio wave measurement device 7 then generates a measured electromagnetic field intensity distribution 6. The measured electromagnetic field intensity distribution 6 in FIG. 1A schematically uses shading to indicate the radio wave intensity at a plane (a reception surface) within the space.

As illustrated in FIG. 1B, the movable radio wave measurement device 7 moves within the room 1, and measures radio wave intensity and direction of arrival at each location within the room 1. The movable radio wave measurement device 7 moves in two dimensions on the floor of the room 1 and the height of the movable radio wave measurement device 7 is variable, whereby radio wave measurement in a three-dimensional space is possible. As a result, the measured electromagnetic field intensity distribution 6 is generated at each location in the room 1. In addition, the movable radio wave measurement device 7, which moves to locations within the room 1, three-dimensionally emits light waves in a plurality of directions from these locations and measures a delay phase for reflected waves for the same light waves to thereby be able to, from these locations, specify, by distance and direction, the spatial positions of points on surfaces of structures inside the room 1.

As illustrated in FIG. 1C, on the basis of the specified spatial positions of a plurality of points on the surface of structures inside the room 1, measurement points 11 corresponding to these spatial positions can be configured as data in a computer resource. It is sufficient if this data can specify coordinates in three dimensions, on the basis of any coordinate system.

As illustrated in FIG. 1D, the measurement points 11 are used to generate a structural model for the room 1 and electromagnetic wave scatterers, namely the shelves 4 and the table 5, in order to configure an electromagnetic field calculation model in a computer resource. The structural model is constructed as a connected group of polygons 12 formed by taking the measurement points 11 as vertexes. Using the connected group, a polygon group 101 that represents the ceiling and the walls, a polygon group 102 that represents the window 2, a polygon group 104 that represents the shelves 4, and a polygon group 105 that represents the table 5 are obtained as structural models for an electromagnetic field calculation. Description is omitted for publicly known portions in techniques for forming an electromagnetic field calculation model. A polygon is illustrated as a triangle in the present embodiment, but another polygon may be employed.

The wireless communication performance evaluation system 100 assigns, as attributes, various electrical characteristics, which are with respect to electromagnetic waves used in wireless communication and are regarding the room 1 and internal structures, namely, the window 2, the door 3, the shelves 4, and the table 5, to respective connected groups among corresponding polygons 12. On the basis of respective material properties and the like, the electrical characteristics are defined in advance and stored in the computer resource.

The wireless communication performance evaluation system 100 uses the calculation model, which is in the computer resource and is represented by each connected group in the polygons 12 that have the various electrical characteristics as attributes, to temporarily provide a transmission point 110 at a location within the computer resource corresponding to a point at which the transceiver 10 is installed within the computer resource.

Rays representing radio waves that travels straight within free space are radiated three-dimensionally in a plurality of directions from this transmission point 110. When this ray collides with a polygon 12, attributes assigned to the connected group to which the polygon 12 is affiliated with are used to calculate a new intensity, phase, and direction, a process for re-radiating rays is repeated, and an estimated electromagnetic field strength distribution 106 corresponding to the measured electromagnetic field intensity distribution 6 is obtained within the computer resource (ray-tracing calculation).

If the behavior of radio waves within real space completely matches the behavior of the calculation model in the computer resource, the measured electromagnetic field intensity distribution 6 should match the estimated electromagnetic field strength distribution 106. However, there is no guarantee that it is possible to faithfully reproduce, within the computer resource, a process in which radio waves travel within a real service area. For example, between the measured electromagnetic field intensity distribution 6 in FIG. 1A and the estimated electromagnetic field strength distribution 106 in FIG. 1D, a mismatch arises at a location that is, from the top-right corner, four squares to the left and two squares forward.

Accordingly, in the present embodiment, the polygons 12 formed in a computational resource are corrected such that the estimated electromagnetic field strength distribution 106 approaches the measured electromagnetic field intensity distribution 6. Specifically, a normal 111 for a polygon 12 is changed. Polygons 12 for which the normal 111 is changed is assumed to be some or all of the polygons 12, as necessary.

In the present embodiment, measurement data for radio wave characteristics obtained in an environment where actual wireless communication is performed is used to correct an electromagnetic field calculation model constructed in a computer resource in order to estimate, using the computer resource, wireless communication characteristics in a service area. Specifically, a structural model for estimating radio wave characteristics in a service area is corrected using radio wave intensities and angles of arrival that are actually measured within the same area.

Accordingly, there are effects that it is possible to improve characteristic prediction accuracy for a wireless communication system that is within a service area and uses a computer resource, it is possible to reduce costs for wireless engineering pertaining to introduction of the wireless communication system within this service area, and there is a cost reduction for wireless engineering pertaining to maintenance of the same system after introduction.

### [Second Embodiment]

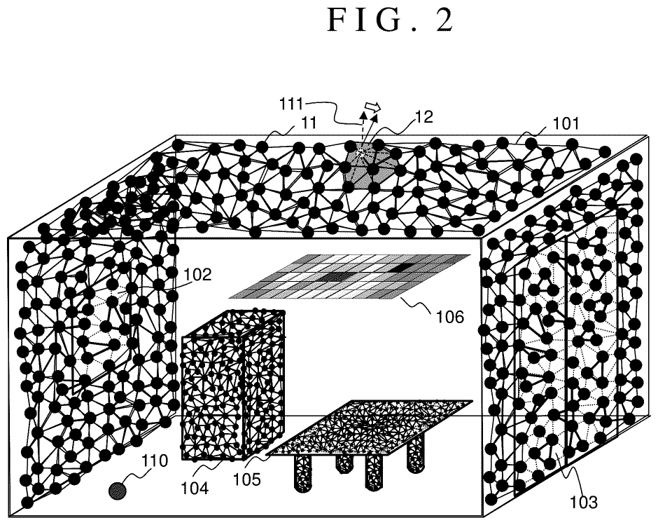

FIG. 2 is a view for describing a configuration of a wireless communication performance evaluation system according to another embodiment. A difference from the first embodiment (FIG. 1D) is that a wireless communication performance evaluation system 100 changes three-dimensional coordinates corresponding to the positions of (if necessary, all) measurement points 11 formed in a computational resource, such that an estimated electromagnetic field strength distribution 106 approaches a measured electromagnetic field intensity distribution 6. Due to this change, the shape and direction of polygons 12 having these measurement points as vertexes changes, and the normal 111 of these polygons 12 also changes.

By virtue of the present embodiment, it is possible to realize a change of the normal of polygons 12 having these measurement points 11, without changing a connection structure (topology) for a connected group to which these polygons 12 are affiliated with. Accordingly, it is possible to make the calculation model within the computer resource approach the topology of a structure present in real space within a service area and therefore, in comparison to the first embodiment, there is an effect of improving characteristic prediction accuracy for the wireless communication system that is within the service area and uses a computer resource.

### [Third Embodiment]

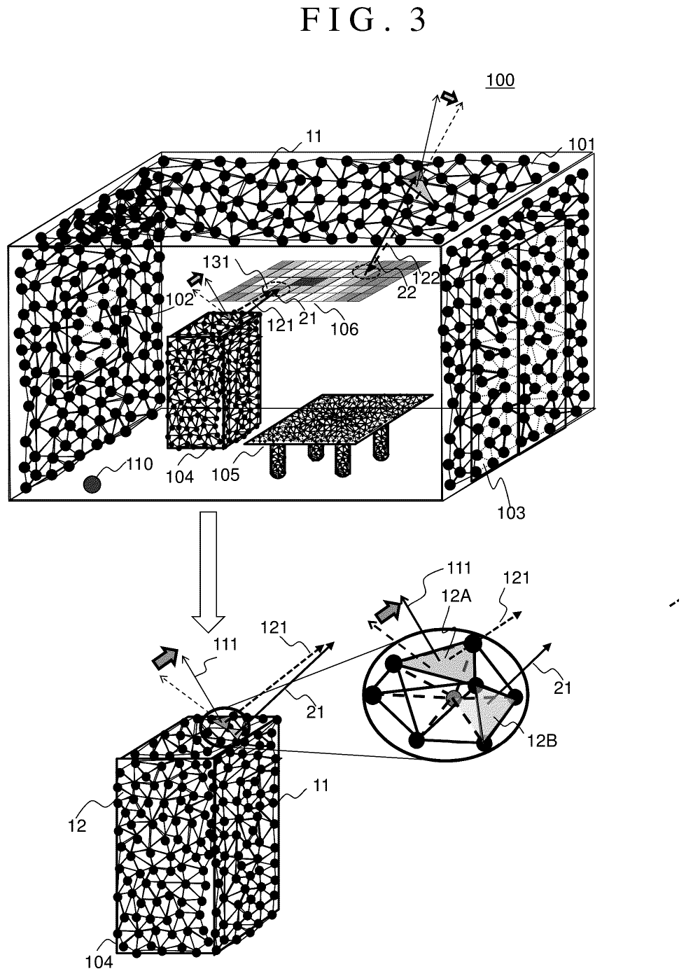

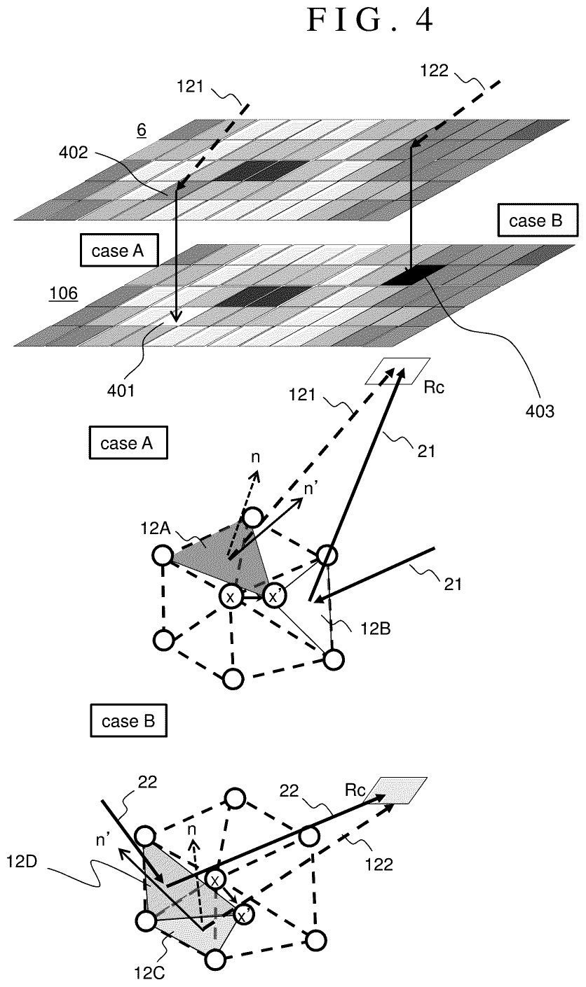

FIG. 3 and FIG. 4 are used to describe another example of a wireless communication performance evaluation system according to an embodiment. In this example, a calculated value for electric field obtained from a calculation model is compared with a measured value, and a measured direction for a radio wave that arrives at a location at which the deviation between the calculated value and the measured value exceeds a tolerance value is used to correct a polygon that faces a corresponding reception point within the same model (and polygons surrounding this polygon).

FIG. 3 is a view for describing a configuration of a wireless communication performance evaluation system that improves the accuracy of a communication performance prediction for a wireless communication system, and reduces the cost of introducing the same system.

FIG. 4 is a view for describing a method of using a measured incoming-wave direction to change a calculation model for an electromagnetic field calculation in a computer resource.

A difference between the first embodiment and the second embodiment is that the wireless communication performance evaluation system 100 identifies, from among measurement points 11 formed in a computational resource, a portion that impacts a region in which there is a large difference between the measured electromagnetic field intensity distribution 6 and the estimated electromagnetic field strength distribution 106.

In order to identify this portion, a radio wave arrival direction measured by the movable radio wave measurement device 7 in real space corresponding to the region where the difference is large is used to estimate this portion by means of measurement points 11 present in this direction of arrival in the computer resource.

Description is given for processing in a case where, with respect to the measured electromagnetic field intensity distribution 6, the estimated electromagnetic field strength distribution 106 has a region 131 that is less than a threshold which is set in advance, as illustrated in FIG. 3. Firstly, seen from this region 131, a polygon 12A present in a direction corresponding to a radio wave arrival direction 121 measured by the movable radio wave measurement device 7 is identified. From among a plurality of polygons 12 sharing a vertex with the polygon 12A, a polygon 12B having a ray 21 that has a maximum intensity from among colliding rays is selected. A vertex belonging to the selected polygon 12B is changed such that the colliding ray 21 reaches the region 131. As a result, the polygons 12 are changed from the broken-line state in FIG. 3 to the solid-line state. In conjunction with this, there is a similarly with the first embodiment (case A) in that the normal 111 of each polygon 12 is changed from being illustrated by a broken line to illustrated by a solid line. Note that, instead of selecting the polygon 12B which has the ray 21 that has the maximum ray intensity, it may be that any polygon for which the intensity of a colliding ray is greater than a ray that collides with the polygon 12A is selected.

FIG. 4 is for describing the above process in detail. With respect to the measured electromagnetic field intensity distribution 6, the estimated electromagnetic field strength distribution 106 is illustrated facing thereto. In the estimated electromagnetic field strength distribution 106, a region 401 in which the intensity is less than that in the measured electromagnetic field intensity distribution 6 is estimated (case A). In the estimated electromagnetic field strength distribution 106, a region 403 in which the intensity is greater than that in the measured electromagnetic field intensity distribution 6 is estimated (case B). By making the measured value approach the estimated value, it becomes possible to virtually reproduce a wireless communication state with good accuracy.

In case A, the region 401 corresponds to a region 402 in real space. The region 402 is set as a reception surface Rc. Because the estimated value indicates a low intensity with respect for the measured value at the reception surface Rc, the system in the embodiment determines that a ray arriving at the reception surface Rc in the calculation model for estimation is not the ray that should properly arrive. By considering the direction for the ray that should properly arrive to be an incoming-wave direction obtained by the measured value, the polygon 12A present in the radio wave arrival direction 121, which is obtained by a measured value and is from the reception surface Rc, is obtained by calculation. This calculation is the same as a procedure for finding a colliding polygon when a ray is emitted from the reception surface Rc, and thus is quickly processed in a normal ray-tracing calculation. Once the polygon 12A, which is considered to emit a ray that intrinsically reaches the reception surface Rc, is identified, polygons surrounding the polygon 12A are included, and the intensities of rays reaching these polygons is checked.

A reason for including polygons surrounding the polygon 12A present in the radio wave arrival direction 121 (or polygons adjacent thereto) is in order to resolve a problem of measurement error in the direction of an incoming wave obtained from a measurement value. In a concrete example, “surrounding polygons” is set as all polygons sharing a vertex with the polygon 12A, which is obtained by radiating a ray from the reception surface Rc in the radio wave arrival direction 121 for the measurement value. In this manner, it is possible to achieve good accuracy while suppressing a scale of calculation required.

In the calculation model, once a polygon (preferred polygon) 12B at which the ray having the strongest intensity arrives from among the plurality of polygons including the surrounding polygons is selected, coordinates for the vertexes of the preferred polygon 12B are changed such that a ray 21 incident on the preferred polygon 12B reaches the reception surface Rc. There are many methods for how to change the coordinates of these vertexes, but, in the example in FIG. 4, a method for selecting a vertex x shared by the preferred polygon 12B and the polygon 12A and changing the coordinates of the vertex x is employed. As another example, there is a method for changing the coordinates of three vertexes in the preferred polygon at the same time.

With an objective of having the measured value for the incoming wave approach the calculated value for the direction of a ray of light, the vertex x in the polygon 12B is changed to x′ as described above. In conjunction therewith, the normal of respective polygons changes. For example, n is the normal of the polygon 12A before the change, and n′ is the normal of the polygon 12A after the change. As a result of such processing, an electromagnetic wave from the polygon 12B reaches the reception surface Rc in place of an electromagnetic wave from the polygon 12A. The electromagnetic wave from the polygon 12A reaches a reception surface different to the reception surface Rc. In addition, in conjunction with this, there are cases where an electromagnetic wave from another polygon and the direction of this electromagnetic wave change.

Description is given for a processing with respect to the region 403 at which, with respect to the measured electromagnetic field intensity distribution 6, the estimated electromagnetic field strength distribution 106 is larger than a threshold set in advance (case B). The region 403 is set as a reception surface Rc. Firstly, seen from this region 403, a polygon 12C present in a direction corresponding to a radio wave arrival direction 122 measured by the movable radio wave measurement device 7 is identified. From among a plurality of polygons 12 sharing a vertex with the polygon 12C, a polygon 12D having a ray 22 that has a minimum intensity from among colliding rays is selected. A vertex belonging to the polygon 12D is changed such that the colliding ray 22 reaches the region 403 (case B). Note that, instead of selecting the polygon 12D which has the ray 22 that has the minimum ray intensity, it may be that any polygon for which the intensity of a colliding ray is less than a ray that collides with the polygon 12C is selected.

By virtue of the present embodiment, because it is possible to significantly reduce the number of measurement points to be changed in order for the estimated electromagnetic field strength distribution 106 to approach the measured electromagnetic field intensity distribution 6, there are effects that it is possible to significantly shorter the amount of time for changing a calculation model in a computer resource by adapting to the real environment, and a cost reduction for wireless engineering pertaining to introduction and maintenance of a wireless communication system in a service area.

### [Fourth Embodiment]

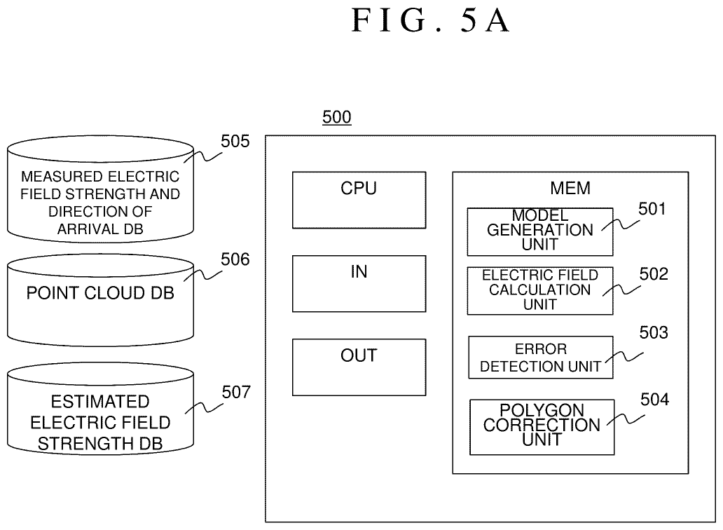

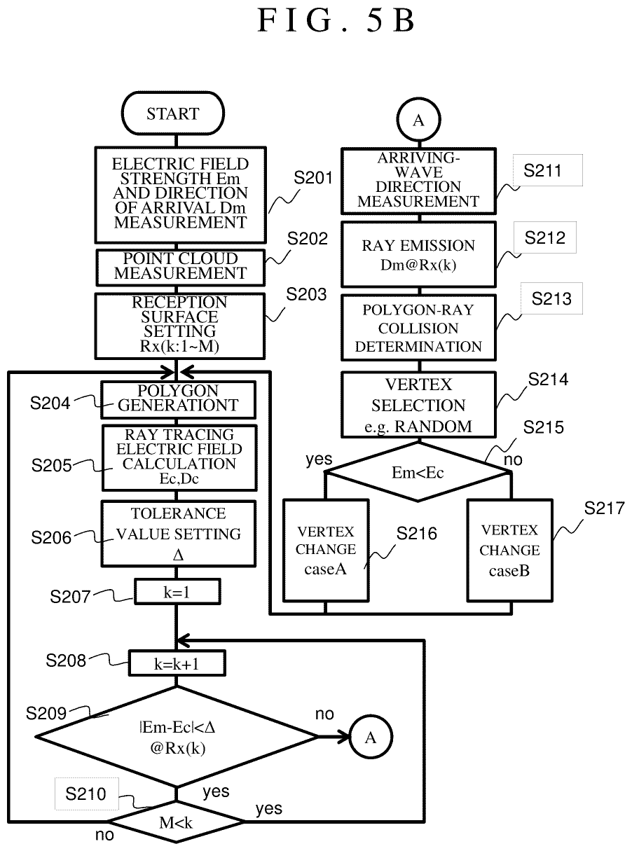

FIG. 5A is a block view for describing a configuration of a wireless communication performance evaluation system according to the third embodiment. A wireless communication performance evaluation system 500 can be configured by a normal computer. The wireless communication performance evaluation system 500 is provided with a processing apparatus CPU, an input apparatus IN, an output apparatus OUT, and a main storage apparatus MEM. The main storage apparatus MEM uses software to implement a model generation unit 501, an electric field calculation unit 502, an error detection unit 503, and a polygon correction unit 504. In addition, as databases, it is possible to use a measured electric field strength and direction of arrival DB 505, a point cloud DB 506, and an estimated electric field strength DB 507.

Each of these elements is connected by a data bus or network (not-illustrated), and can send and receive commands or data. Note that these configurations may be configured by a single computer or may be realized by a plurality of computers cooperating, as with a cloud. Operation for each component is described below.

FIG. 5B is a view for describing a flow for operation by the wireless communication performance evaluation system according to the third embodiment. Description is given while referring to FIG. 1 through FIG. 5A. Firstly, at an optionally-defined timing, the movable radio wave measurement device 7 measures an electric field strength Em and a direction of arrival Dm at a plurality of optionally-defined locations within a service area (S201). The measured data is stored in the measured electric field strength and direction of arrival DB 505.

Next, using the movable radio wave measurement device 7, the installation position of the movable radio wave measurement device 7 and a direction and distance from this installation position are used to identify points on the surface of structures within the service area, and represent a point cloud, which is a grouping of points, as coordinates within a computer resource as illustrated in FIG. 1C (S202). Note that execution may be by an apparatus that is different to the movable radio wave measurement device 7. Data for a point cloud represented as coordinates is stored in the point cloud DB 506.

In the electric field calculation unit 502, an optionally-defined number (M) of reception surfaces Rx, which are regions for obtaining an electromagnetic field intensity within a computer resource, are set (S203). Each reception surface Rx corresponds to the region 401 in FIG. 4. As described above, the computer resource can be realized by a computer such as a typical server, and the following processing is assumed to be implemented by software.

On the basis of data in the point cloud DB, the model generation unit 501 generates a polygon 12 having, as vertexes, three or more points included in a point cloud within a computer resource, and constructs a structural model as illustrated in FIG. 1D (S204).

Furthermore, the model generation unit 501 associates, with the polygon 12 formed in the computer resource, a physical constant with respect to an electromagnetic wave for a corresponding structure in real space and generates, in a computational resource, a calculation model that is for an electromagnetic field calculation and corresponds to a real-space wireless communication service area.

The electric field calculation unit 502 uses this calculation model to perform a ray-tracing calculation. A transmission point 110 is temporarily provided in the computer resource, and a ray that simulates a radio wave that travel straight in free space is emitted in many directions in three-dimensional space from this transmission point 110. In a case where a ray that is emitted from the transmission point 110 and travels straight has collided with the polygon 12, using the physical constant related to the structure corresponding to this polygon, a radiation direction from this polygon, an initial electric field strength, and a phase are calculated, and then a process for causing re-radiation of the ray is repeated. When the ray has collided with a reception surface Rx, an electric field strength Ec and a phase Dc for the ray are recorded, in association with the reception surface Rx, in the estimated electric field strength DB 507. In a case where energy for all rays emitted from the transmission point is less than a reference value that is defined in advance, the process is ended, as a result of which data that pertains to the reception surface Rx and is for estimating an electromagnetic field distribution in the area is obtained (S205).

The error detection unit 503 sets a tolerance value Δ (S206) that is used in a comparison with a radio wave characteristic in real space obtained using the movable radio wave measurement device 7 and, using data in the measured electric field strength and direction of arrival DB 505 and data in the estimated electric field strength DB 507, compares a radio wave intensity Em measured by the movable radio wave measurement device 7 and corresponding to all reception surfaces Rx with a vector sum of the estimated electric field strength Ec corresponding to each reception surface Rx, the vector sum being obtained using the phase Dc (S207, S208, S209, S210).

In a case where the measured value for radio wave intensity differs from the vector sum of electric field strengths corresponding to Rx (no in S209), the polygon correction unit 504 obtains, from data in the measured electric field strength and direction of arrival DB 505, a measured value for a radio wave arrival direction measured using the movable radio wave measurement device 7 at a location in real space corresponding to the respective reception surface Rx (S211). Using this measured value, a ray is emitted from Rx in the direction of arrival (S212), and a polygon that this ray collides with is identified (S213).

The polygon correction unit 504 selects a vertex in the identified polygon in accordance with the description of the embodiment in FIG. 4 or randomly (S214), and changes coordinates for the selected vertex (S215, S216, S217). In a case where a change is performed for a vertex in the polygon, the processing in S204 is returned to. When the electric field strength comparison (S209) at all reception surfaces has ended (no in S210), the process ends or the polygon generation (S204) resumes.

By virtue of the present embodiment, an electromagnetic field calculation model used by a computer resource for predicting a wireless communication characteristic within a service area for a wireless communication system can be used to adaptively change/correct a radio wave intensity distribution within the area while the system is operating, in accordance with an operational status of the same system. Accordingly, there is an effect in that the operational flexibility of the wireless communication performance evaluation system according to the embodiment increases, and there are more uses for the same system.

### [Fifth Embodiment]

Description is given for an example of a structure and a circuit configuration of a radio wave characteristic measurement device used by a wireless communication characteristic prediction system according to an embodiment.

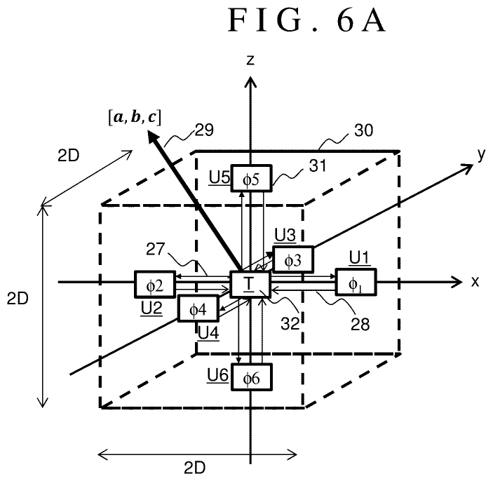

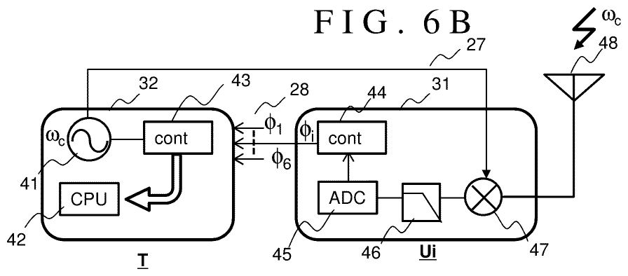

FIG. 6A is a transparent perspective view that illustrates an example of the structure of a radio wave characteristic measurement device used by a wireless communication characteristic prediction system according to an embodiment. Secondary station units 31 are installed at the center of the six faces of a virtual cube 30 that is installed in a three-dimensional Cartesian coordinate system for representing the coordinates of a received wave arrival vector 29, the virtual cube 30 having edges 2D. A primary station unit 32 is installed at the center of gravity of the virtual cube 30. In FIG. 6A, the secondary station units 31 are written as Ui, and the primary station unit 32 is written as T.

The single primary station unit 32 and each of the six secondary station units 31 are joined by a high-frequency cable 27 for transmitting a signal belonging to a carrier wave frequency band and a low-frequency cable 28 for transmitting a digital signal. The high-frequency cables 27 are of equal lengths. Antennas mounted to the plurality of secondary station units 31 installed in the virtual cube 30 are installed at three-dimensionally equal intervals (D) with respect to the center of gravity of the virtual cube 30.

FIG. 6B is a circuit diagram that illustrates an example of a circuit configuration of a radio wave characteristic measurement device used by a wireless communication characteristic prediction system according to an embodiment. The primary station unit 32 is provided with a carrier wave frequency generation circuit 41 that generates a signal having a frequency equal to the carrier wave frequency used by the wireless communication system, and a primary station controller 43 that controls the carrier wave frequency generation circuit 41. The primary station controller 43 is joined to a centralized control circuit 42.

A secondary station unit 31 is provided with a secondary station antenna 48. A cascade connection of a high-frequency mixer 47, a low pass filter 46, and an analog-to-digital converter 45 is connected to the secondary station antenna 48. A signal received by the secondary station antenna 48 is down-converted, only a low-frequency signal component is inputted to the analog-to-digital converter 45 and converted to a digital signal, and this digital signal is inputted to a secondary station controller 44.

An output from the carrier wave frequency generation circuit 41 in the primary station unit 32 is inputted, as a local signal, to the high-frequency mixer 47 in the secondary station units 31 via the isometric high-frequency cables 27. The secondary station controller 44 in each secondary station unit 31 uses a digital signal, which is obtained based on the output signal from the carrier wave frequency generation circuit 41 in the primary station unit 32, to calculate the phase of the signal received by the secondary station antenna 48. The secondary station controller 44 transmits the calculated phase for the received signal to the primary station controller 43 in the primary station unit 32, via the low-frequency cable 28.

The primary station unit 32 can use a relative phase, which is for a radio wave received by the secondary station antenna 48 provided in the secondary station unit 31 and is transmitted from the secondary station unit 31, and a spatial position of the secondary station antenna to calculate a radio wave arrival direction in the three-dimensional Cartesian coordinate system.

In addition, various publicly known radio wave intensity measurement techniques may be employed for measurement of radio wave intensity. Details regarding publicly known portions are omitted.

By virtue of the present embodiment, because it is possible to measure radio wave intensity and direction of arrival at each point within a service area for a wireless communication system, it is possible to significantly reduce an amount of numerical computation for when a wireless communication characteristic prediction system according to the embodiment corrects a calculation model for estimating a value for an electromagnetic wave at each location in the service area, and there is an effect of reducing introductory and maintenance costs accompanying a reduction of person-hours for wireless engineering necessary to introduce and maintain a wireless system.

### [Sixth Embodiment]

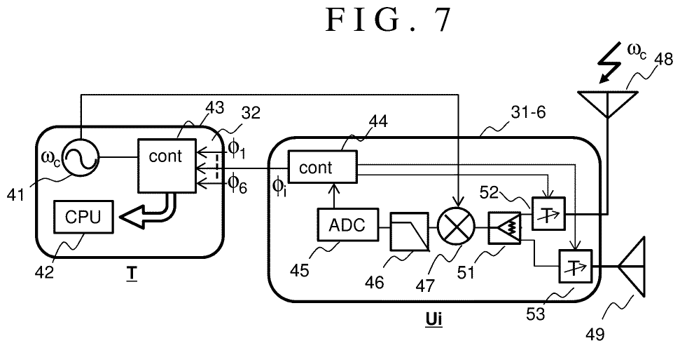

FIG. 7 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. A difference from the embodiment in FIG. 6A and FIG. 6B is that secondary station units 31-6 are provided in place of secondary station units 31.

Each secondary station unit 31-6 is provided with a first secondary station antenna 48 and a second secondary station antenna 49, which are in an orthogonal relationship with respect to each other spatially. A first variable attenuator 52 and a second variable attenuator 53 are joined to the first secondary station antenna 48 and the second secondary station antenna 49, and outputs from these two are added together and outputted by a high-frequency combining circuit 51.

A cascade connection of a high-frequency mixer 47, a low pass filter 46, and an analog-to-digital converter 45 is connected to the high-frequency combining circuit 51. Signals received by the first secondary station antenna 48 and the second secondary station antenna 49 are weighted by amplitude and combined, a result of the combining is subsequently down-converted such that only a low-frequency signal component is inputted to the analog-to-digital converter 45 and converted to a digital signal, and the digital signal is inputted to the secondary station controller 44.

The secondary station controller 44 weights one of attenuation for the first variable attenuator 52 and the second variable attenuator 53 by a cosine function and the other by a sine function, as a result of which it is possible to change a direction for receiving energy of a radio wave that arrives at the secondary station unit 31-6 at maximum power or a direction for receiving energy at minimum power, using the first secondary station antenna 48 and the second secondary station antenna 49.

Because an electromagnetic wave is a transverse wave, there is polarization in a direction of an energy vector for an electric field within a plane orthogonal to the direction of travel, and it is possible to know polarization of an incoming radio wave due to a direction for receiving at maximum power and a direction for receiving a minimum power, which are orthogonal to each other.

By virtue of the present embodiment, because it is possible to measure a direction of arrival and polarization for a radio wave at each point within a service area for a wireless communication system, a wireless communication characteristic prediction system according to the embodiment can improve the calculation accuracy for estimating a value for an electromagnetic wave at each location in the service area, and there is an effect of improving the accuracy of wireless communication characteristic predictions for within the service area.

### [Seventh Embodiment]

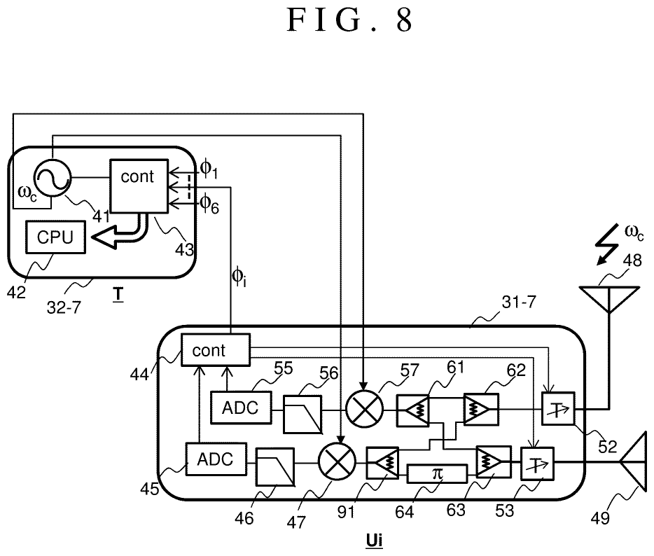

FIG. 8 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. A difference from the embodiment in FIG. 7 is that secondary station units 31-7 are provided instead of the secondary station units 31-6, and a primary station unit 32-7 is provided instead of the primary station unit 32.

Each secondary station unit 31-7 is provided with a first secondary station antenna 48 and a second secondary station antenna 49, which are in an orthogonal relationship with respect to each other spatially. A first variable attenuator 52 and a second variable attenuator 53 are joined to the first secondary station antenna 48 and the second secondary station antenna 49, and respective outputs therefrom are bifurcated by each of a first high-frequency distributor 62 and a second high-frequency distributor 63.

One branch output from each distributor are directly combined by a second high-frequency combiner 61, a combined output is down-converted at a carrier wave frequency by a cascade connection of a second high-frequency mixer 57, a second low pass filter 56, and a second analog-to-digital converter 55, a result of the down-conversion is converted to a digital signal, and the digital signal is transmitted to a secondary station controller 44.

The other branch output from each distributor are combined by the second high-frequency combiner 61, the signal pertaining to the second high-frequency distributor 63 going via a half-wavelength line 64 for the carrier wave frequency band and the signal pertaining to the first high-frequency distributor 62 being directly connected.

An output from the carrier wave frequency generation circuit 41 in the primary station unit 32-7 is inputted, as a local signal, to the high-frequency mixer 47 and the high-frequency mixer 57 in the secondary station units 31-7 via the isometric high-frequency cables 27.

A combined output is down-converted at the carrier wave frequency by the cascade connection of a first high-frequency mixer 47, a first low pass filter 46, and a first analog-to-digital converter 45, a result of the down-conversion is converted to a digital signal, and the digital signal is transmitted to the secondary station controller 44. The secondary station controller 44 can weight one of attenuation for the first variable attenuator 52 and the second variable attenuator 53 by a cosine function and the other by a sine function, as a result of which it is possible realize, by referring to a maximum value and a maximal value for the two obtained digital signals, control for making energy of a radio wave that arrives at the secondary station unit 31-7 be in a direction for receiving at maximum power, using the first secondary station antenna 48 and the second secondary station antenna 49. Accordingly, it will be possible to improve measurement accuracy for polarization of an incoming radio wave.

By virtue of the present embodiment, in comparison to the embodiment in FIG. 7, it is possible to improve wireless communication characteristic prediction performance for within a service area for a wireless communication system.

### [Eighth Embodiment]

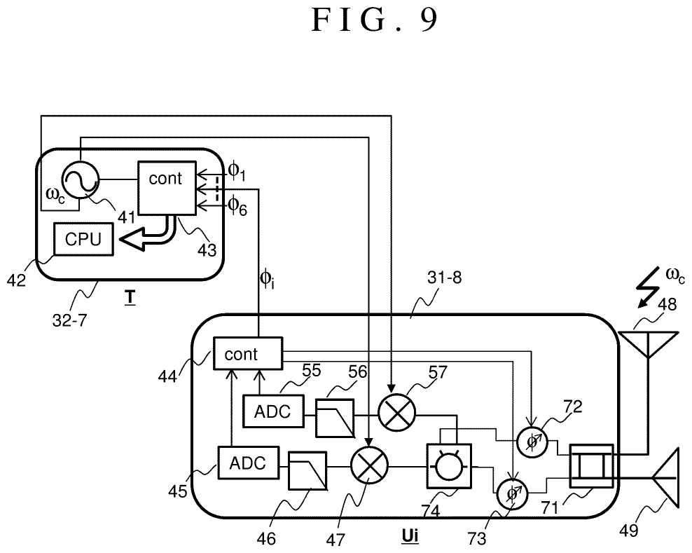

FIG. 9 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. A difference from the embodiment in FIG. 8 is that secondary station units 31-8 are provided in place of secondary station units 31-7.

Each secondary station unit 31-8 is provided with a first secondary station antenna 48 and a second secondary station antenna 49, which are in an orthogonal relationship with respect to each other spatially. The first secondary station antenna 48 and the second secondary station antenna 49 are connected to a third port and a fourth port in a hybrid circuit 71. A first port and a second port in the hybrid circuit 71 are joined to a second port and a fourth port in a rat-race circuit 74 via a first high frequency variable phase shifter 72 and a second high-frequency variable phase shifter 73, respectively.

A third port in the rat-race circuit 74 is joined to a cascade connection of a second high-frequency mixer 57, a second low pass filter 56, and a second analog-to-digital converter 55. A signal received by the first secondary station antenna 48 and the second secondary station antenna 49 is down-converted at a carrier wave frequency, a result of the down-conversion is converted to a digital signal, and the digital signal is transmitted to a secondary station controller 44.

A first port in the rat-race circuit 74 is joined to a cascade connection of a first high-frequency mixer 47, a first low pass filter 46, and a first analog-to-digital converter 45. A signal received by the first secondary station antenna 48 and the second secondary station antenna 49 is down-converted at a carrier wave frequency, a result of the down-conversion is converted to a digital signal, and the digital signal is transmitted to a secondary station controller 44.

By virtue of the present embodiment, it is possible to use the first high frequency variable phase shifter 72 and the second high-frequency variable phase shifter 73 in accordance with the secondary station units 31-8 to realize operation that is similar to the operation of the secondary station units 31-7 which use the variable attenuators 52 and 53 and are according to the embodiment in FIG. 8. Accordingly, reducing electric power consumption and decreasing noise in received signals is addressed for secondary station units, and reducing costs for wireless engineering is addressed by lengthening an amount of continuous operating time and improving radio wave characteristic measurement accuracy for a movable radio wave characteristic measurement device.

### [Ninth Embodiment]

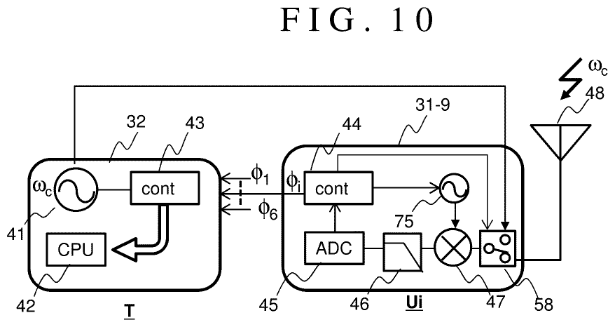

FIG. 10 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. A difference from the embodiment in FIG. 6A and FIG. 6B is that secondary station units 31-9 are provided in place of secondary station units 31.

A secondary station unit 31-9 is provided with a secondary station antenna 48. The secondary station antenna 48 is joined to one branch terminal of a secondary station input switching switch 58. A cascade connection of a high-frequency mixer 47, a low pass filter 46, and an analog-to-digital converter 45 is connected to a common terminal in the secondary station input switching switch 58.

The high-frequency mixer 47 is joined to a secondary station high-frequency generation circuit 75 that supplies a local signal belonging to a carrier wave frequency band. The other branch terminal in the secondary station input switching switch 58 is joined to an output from a carrier wave frequency generation circuit 41 in the primary station unit 32. A secondary station controller 44 controls the secondary station input switching switch 58.

A signal received by the secondary station antenna 48 is down-converted, only a low-frequency signal component is inputted to the analog-to-digital converter and converted to a digital signal, and this digital signal is inputted to the secondary station controller 44.

The secondary station unit 31-9 controls the secondary station input switching switch 58 such that the output from the secondary station antenna 48 is inputted to the high-frequency mixer 47, and measures the phase of a received wave that arrives at the movable radio wave measurement device 7. Subsequently, the secondary station input switching switch 58 is controlled such that the output from the carrier wave frequency generation circuit 41 in the primary station unit 32 is inputted to the high-frequency mixer 47, and the phase of the output from the carrier wave frequency generation circuit 41 is measured. Each phase measurement result is transmitted to a primary station controller 43 in the primary station unit 32 via a low-frequency cable 28.

The primary station unit 32 can use the relative phases that are transmitted from the secondary station unit 31-9 and are between the radio wave received by the secondary station antenna 48 and the output from the carrier wave frequency generation circuit 41 and the spatial position of the secondary station antenna 48 to calculate a direction of arrival in the three-dimensional Cartesian coordinate system.

By virtue of the present embodiment, a secondary station unit can be supplied, by an internal carrier wave frequency generation circuit, with a local signal for measuring the phase of an incoming wave without being supplied with such a local signal via a cable from an external unit. Accordingly, there is an effect of stabilizing a mixer operation for down-converting a signal for an incoming wave, and it is possible to improve the accuracy of measuring the phase of the incoming wave.

### [Tenth Embodiment]

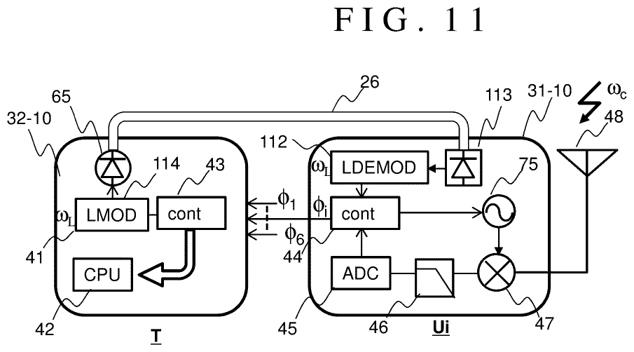

FIG. 11 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. Differences from the embodiment in FIG. 6A and FIG. 6B is that secondary station units 31-10 are provided instead of secondary station units 31, a primary station unit 32-10 is provided instead of the primary station unit 32, and an optical fiber 26 for transmitting a light-wave signal is present between the secondary station units 31-10 and the primary station unit 32-10 instead of a high-frequency cable 27.

The primary station unit 32-10 is provided with a photo LED 65, and the photo LED 65 produces, with a light wave having a frequency of an order greater than that of a carrier wave frequency, a synchronization signal which is generated by an optical modulator 114. The primary station controller 43 controls a frequency for the optical modulator 114, and the primary station controller 43 is joined to a centralized control circuit 42.

Each secondary station unit 31-10 is provided with a secondary station antenna 48. A cascade connection of a high-frequency mixer 47, a low pass filter 46, and an analog-to-digital converter 45 is connected to the secondary station antenna 48. The high-frequency mixer 47 is joined to a secondary station high-frequency generation circuit 75 that supplies a local signal belonging to a carrier wave frequency band, and the secondary station controller 44 controls the frequency for the secondary station high-frequency generation circuit 75. A signal received by the secondary station antenna 48 is down-converted, only a low-frequency signal component is inputted to the analog-to-digital converter and converted to a digital signal, and this digital signal is inputted to a secondary station controller 44.

A synchronization signal produced by the primary station unit 32-10 is transmitted to a photodiode 113 via the optical fiber 26. A signal received by the photodiode 113 is converted to a digital signal by an optical demodulator 112, and the digital signal is inputted to the secondary station controller 44. The secondary station controller 44 calculates the phase of the secondary station high-frequency generation circuit 75 with respect to the synchronization signal.

The secondary station unit 31-10 determines the phase of a received wave, based on an initial phase for the secondary station high-frequency generation circuit that each secondary station unit 31-10 is provided with. A receiving unit 35, after receiving a radio wave, transmits to the primary station unit 32-10 a measured phase for this radio wave and the relative phase of the secondary station high-frequency generation circuit 75 with respect to the synchronization signal produced by the primary station unit 32-10.

The primary station unit 32-10 can use these two types of phases transferred from each secondary station unit 31-10 to estimate a direction of arrival for a radio wave from a wireless communication system arriving at the movable radio wave measurement device 7.

By virtue of the present embodiment, because it is possible to use an optical fiber instead of a high-frequency cable to join a secondary station unit with a primary station unit, there is an effect of weight saving and lower costs for an apparatus, due to the miniaturization and weight saving for components needed to manufacture a radio wave characteristic measurement device used by a wireless communication characteristic prediction system according to an embodiment.

### [Eleventh Embodiment]

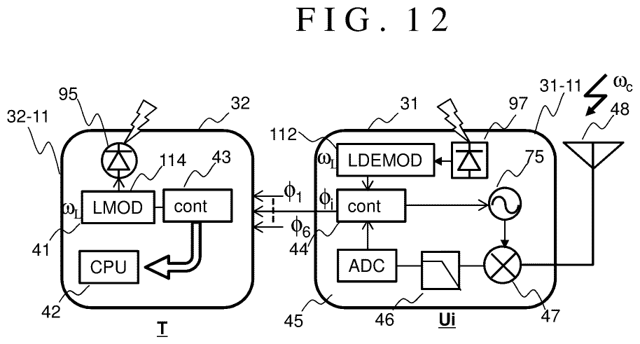

FIG. 12 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. Differences from the embodiment in FIG. 11 is that secondary station units 31-11 are provided instead of secondary station units 31-10, a primary station unit 32-11 is provided instead of the primary station unit 32-10, and the optical fibers 26 present between the secondary station units 31 and the primary station unit 32 has been removed.

The primary station unit 32-11 is provided with a high-output photo LED 95 instead of the photo LED 65, and each secondary station unit 31-11 is provided with a high-sensitivity photodiode 97 instead of the photodiode 113. The high-output photo LED 95 produces, with a light wave having a frequency of an order greater than that of a carrier wave frequency, a synchronization signal which is generated by an optical modulator 114. Because the high-output photo LED 95 and the high-sensitivity photodiode 97 communicate optically, it is possible to optically transmit a synchronization signal using free space.

By virtue of the present embodiment, because it is possible to remove optical fibers joining the secondary station units with the primary station unit, there is an effect of apparatus weight saving and lower costs in relation to a radio wave characteristic measurement device used by a wireless communication characteristic prediction system, in comparison to the embodiment in FIG. 11.

### [Twelfth Embodiment]

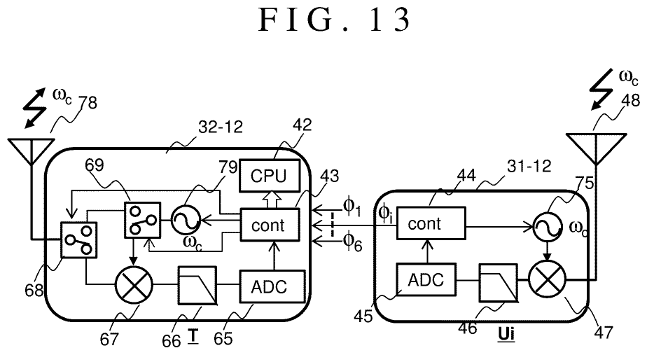

FIG. 13 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. Differences from the embodiment in FIG. 6A and FIG. 6B is that secondary station units 31-12 are provided instead of secondary station units 31, a primary station unit 32-12 is provided instead of the primary station unit 32, and there is no high-frequency cable for transmitting a high-frequency signal between the secondary station units 31 and the primary station unit 32.

The primary station unit 32-12 is provided with a primary station antenna 78. A cascade connection of a primary station high-frequency mixer 67, a primary station low pass filter 66, and a primary station analog-to-digital converter 65 is connected to the primary station antenna 78 via a primary station transmit/receive switching switch 68. The primary station high-frequency mixer 67 is joined, via a primary station high-frequency switch 69, to a primary station high-frequency generation circuit 79 that supplies a local signal belonging to a carrier wave frequency band, and a primary station controller 43 controls the frequency for the primary station high-frequency generation circuit 79.

The primary station controller 43 controls the primary station transmit/receive switching switch 68 and the primary station high-frequency switch 69. When the primary station unit 32-12 receives an incoming wave, the switching terminal of the primary station transmit/receive switching switch 68 is switched to the signal input for the primary station high-frequency mixer 67, the common terminal of the primary station transmit/receive switching switch 68 being joined to the primary station antenna 78, and the switching terminal of the primary station high-frequency switch 69 is switched to the local input of the primary station high-frequency mixer 67, the common terminal of the primary station high-frequency switch 69 being joined to the primary station high-frequency generation circuit 79. A signal received by the primary station antenna 78 is down-converted such that only a low-frequency signal component is inputted to the primary station analog-to-digital converter 65 and converted to a digital signal, the digital signal is inputted to the primary station controller 43, and the primary station controller 43 is joined to a centralized control circuit 42.

Each secondary station unit 31-12 is provided with a secondary station antenna 48. A cascade connection of a high-frequency mixer 47, a low pass filter 46, and an analog-to-digital converter 45 is connected to the secondary station antenna 48. The high-frequency mixer 47 is joined to a secondary station high-frequency generation circuit 75 that supplies a local signal belonging to a carrier wave frequency band. The secondary station controller 44 controls a frequency for the secondary station high-frequency generation circuit 75. A signal received by the secondary station antenna 48 is down-converted, only a low-frequency signal component is inputted to the analog-to-digital converter 45 and converted to a digital signal, and this digital signal is inputted to a secondary station controller 44.

When the primary station unit 32-12 transmits a reference signal, the switching terminal for the primary station transmit/receive switching switch 68, the common terminal of which is joined to the primary station antenna 78, joins with the switching terminal of the primary station high-frequency switch 69. The output from the primary station high-frequency generation circuit 79 is transmitted as a reference wave from the primary station antenna 78.

Each secondary station unit 31-12 determines the phase of a received wave, based on an initial phase for the secondary station high-frequency generation circuit 75 that each secondary station unit 31-12 is provided with. The primary station unit 32-12 transmits the output from the primary station high-frequency generation circuit 79 at a timing when there is no signal belonging to a frequency band the wireless system uses for communication or control.

Because the frequency band of a carrier wave for an incoming wave in the wireless system that the secondary station unit 31-12 receives is the same as the frequency band for the reference wave transmitted by the primary station unit 32-12, a receiving unit 35 can measure two types of different phases. If there is a prior arrangement for each secondary station unit 31-12 to, after receiving a radio wave, immediately transmit a measured phase for the radio wave to the primary station unit 32-12, the primary station unit 32-12 can identify whether the radio wave received by the secondary station unit 31-12 is a radio wave used by the wireless system or a radio wave transmitted by the primary station unit 32-12, the identification being performed using the timing at which the transmission has been performed from the secondary station unit 31-12.

The primary station unit 32-12 can use these two types of phases transferred from each secondary station unit 31-12 to estimate a direction of arrival for a radio wave from a wireless communication system arriving at the movable radio wave measurement device 7.

By virtue of the present embodiment, a plurality of secondary stations provided with antennas are disposed at equal intervals in three dimensions with respect to one primary station that is provided with an antenna, a measurement value for the phase of an incoming wave measured by the plurality of secondary stations is transmitted to the primary station, and the primary station calculates the direction of the incoming wave using a measurement value for the phase of the incoming wave measured by the primary station itself as well as the measurement values of the phase of the incoming wave that have been transmitted from the secondary stations. Because high-frequency cables for joining the secondary station units with the primary station unit are unnecessary, there is an effect of weight saving and lower costs for an apparatus, due to the elimination of components needed to manufacture a radio wave characteristic measurement device used by a wireless communication characteristic prediction system.

### [Thirteenth Embodiment]

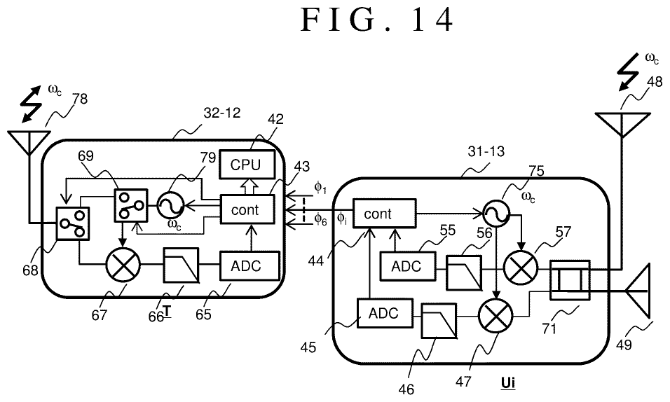

FIG. 14 is a view for describing an example of the structure and circuit configuration of another radio wave characteristic measurement device used by a wireless communication characteristic prediction system according to an embodiment. A geometric arrangement between secondary station units 31 and a primary station unit 32 may be similar to that in FIG. 6A. A difference from the embodiment in FIG. 13 is that secondary station units 31-13 are provided in place of secondary station units 31-12.

Each secondary station unit 31-13 is provided with a first secondary station antenna 48 and a second secondary station antenna 49, which are in an orthogonal relationship with respect to each other spatially. The first secondary station antenna 48 and the second secondary station antenna 49 are connected to a third port and a fourth port in a hybrid circuit 71. A cascade connection of a first high-frequency mixer 47, a first low pass filter 46, and a first analog-to-digital converter 45 is connected to a second port in the hybrid circuit 71. A cascade connection of a second high-frequency mixer 57, a second low pass filter 56, and a second analog-to-digital converter 55 is connected to a first port in the hybrid circuit 71.

Output from a secondary station high-frequency generation circuit 75 that supplies a local signal belonging to a carrier wave frequency band is joined to the first high-frequency mixer 47 and the second high-frequency mixer 57, and the secondary station controller 44 controls the frequency for the secondary station high-frequency generation circuit 75. Signals received by the first secondary station antenna 48 and the second secondary station antenna 49 are down-converted and converted to digital signals, and the digital signals are inputted to the secondary station controller 44. The secondary station unit 31-13 employs the output from the secondary station high-frequency generation circuit 75 as a local signal, and signals received by the first secondary station antenna 48 and the second secondary station antenna 49 are down-converted and then converted to digital signals on two paths.

At this time, a digital signal pertaining to a first path and a digital signal pertaining to a second path become a cosine value and a sine value with respect to a polarization angle within a plane established by the first secondary station antenna 48 and the second secondary station antenna 49. As a result, the secondary station controller 44 can immediately identify polarization for a radio wave received by a radio wave characteristic measurement device. Furthermore, when the frequency for the secondary station high-frequency generation circuit 75 is made to be variable and a small frequency deviation is provided for the carrier wave frequency, the two digital signal values inputted to the secondary station controller 44 change with a rotation relationship due to the deviation frequency, and thus it becomes possible to identify polarization for a received radio wave on a time axis, and it is possible to improve the accuracy of measuring this polarization.

A method of obtaining, in accordance with the primary station unit 32-12, the direction of arrival of a received wave using calculated values of phases for received waves transmitted by the secondary station units 31-13 is similar to the embodiment in FIG. 13.

By virtue of the present embodiment, there is an effect of addressing improving the accuracy of measuring polarization and the angle of arrival of a receiving radio wave, as well as weight saving and lower costs for a radio wave characteristic measurement device used by a wireless communication characteristic prediction system.

### [Fourteenth Embodiment]

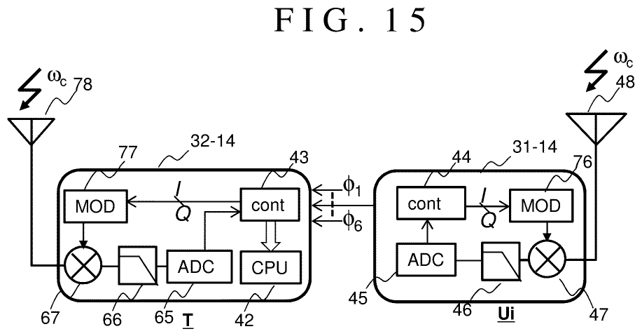

FIG. 15 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. Differences from the circuit configuration of the radio wave characteristic measurement device in the embodiment in FIG. 13 is that the secondary station high-frequency generation circuit 75 is replaced by a secondary station quadrature modulator 76 in each secondary station unit 31-14, and the primary station high-frequency generation circuit 79 is replaced by a primary station quadrature modulator 77 in the primary station unit 32-14.

The secondary station quadrature modulator 76 and the primary station quadrature modulator 77 are supplied with digital I/Q signals from the secondary station controller 44 and the primary station controller 43, and can generate a signal belonging to a carrier wave frequency band at any optionally-defined initial phase in response to the I/Q signals.

By virtue of the present embodiment, because it is possible to realize a variable frequency generation circuit by a digital circuit, there is an effect of miniaturization and lower costs for the radio wave characteristic measurement device.

### [Fifteenth Embodiment]

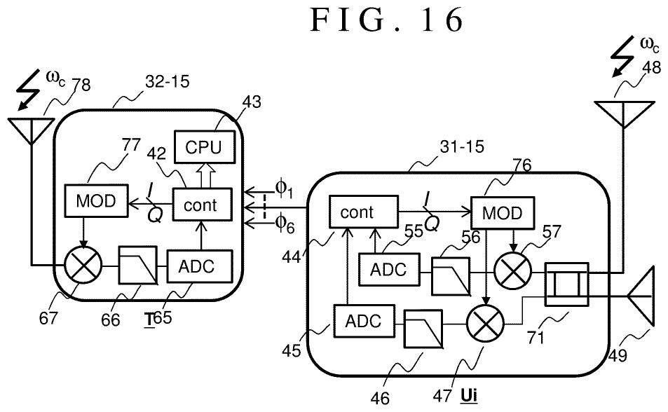

FIG. 16 is a view for describing an example of a circuit configuration of another radio wave characteristic measurement device used by a wireless communication characteristic prediction system according to an embodiment. A geometric arrangement between secondary station units 31 and a primary station unit 32 may be similar to that in FIG. 6A. Differences from the circuit configuration of the radio wave characteristic measurement device in the embodiment in FIG. 14 is that the secondary station high-frequency generation circuit 75 is replaced by a secondary station quadrature modulator 76 in each secondary station unit 31-15, and the primary station high-frequency generation circuit 79 is replaced by a primary station quadrature modulator 77 in the primary station unit 32-15.

The secondary station quadrature modulator 76 and the primary station quadrature modulator 77 are supplied with digital I/Q signals from the secondary station controller 44 and the primary station controller 43, and can generate a signal belonging to a carrier wave frequency band at any optionally-defined initial phase in response to the I/Q signals.

An effect by the present embodiment with respect to the embodiment in FIG. 14 is similar to the effect that the embodiment in FIG. 14 has with respect to the embodiment in FIG. 12.

### [Sixteenth Embodiment]

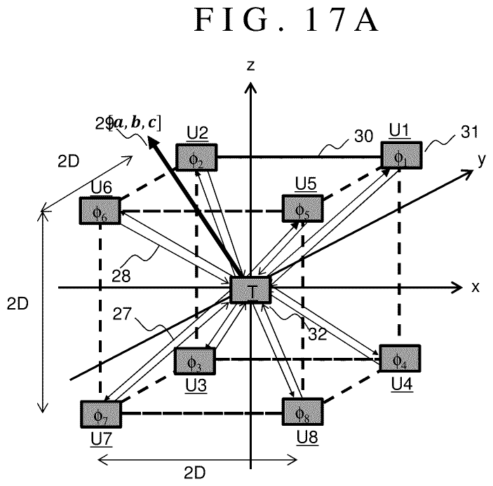

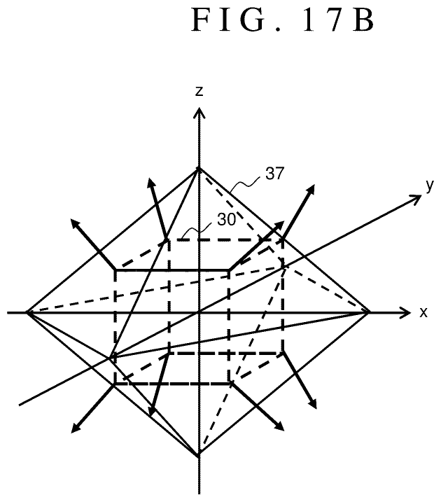

FIG. 17A and FIG. 17B are views for describing an example of the structure of another radio wave characteristic measurement device used by a wireless communication characteristic prediction system according to an embodiment.

As illustrated in FIG. 17A, secondary station units 31 are installed at the eight vertexes of a virtual cube 30 that has edges 2D and is installed in a three-dimensional Cartesian coordinate system, and a primary station unit 32 is installed at the center of gravity of the virtual cube 30.

The single primary station unit 32 and each of the eight secondary station units 31 are joined by a high-frequency cable 27 for transmitting a signal belonging to a carrier wave frequency band and a low-frequency cable 28 for transmitting a digital signal. The high-frequency cables 27 are of equal lengths.

Antennas mounted to the plurality of secondary station units 31 installed in the virtual cube 30 are installed at three-dimensionally equal intervals (√3D) with respect to the center of gravity of the virtual cube 30.

As illustrated in FIG. 17B, if a regular octahedron 37 circumscribing the virtual cube 30 is used, it is possible to install the eight secondary station units 31 at the eight faces of the regular octahedron 37, and thus the robustness of the structure of the radio wave characteristic measurement device is improved.

Because there are more relative phases for a radio wave received by each antenna which are uniformly distributed in three-dimensional space and the primary station unit can use these relative phases in order to determine a direction of arrival for the radio wave, improvement of the accuracy of calculating the direction of arrival is also realized.

By virtue of the present embodiment, with respect to the embodiment in FIG. 6, there is an effect of reducing prediction error for the direction of arrival of a received radio wave while also maintaining robustness for the radio wave characteristic measurement device.

### [Seventeenth Embodiment]

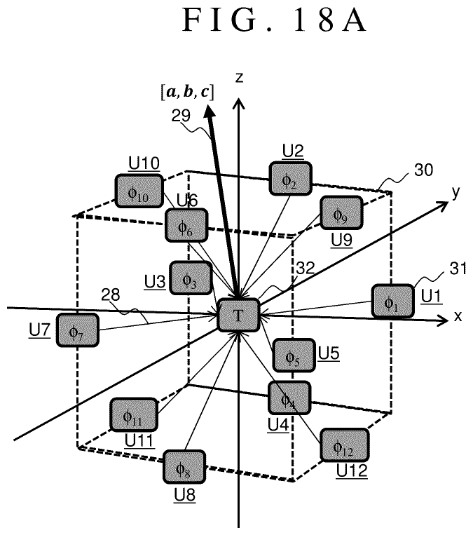

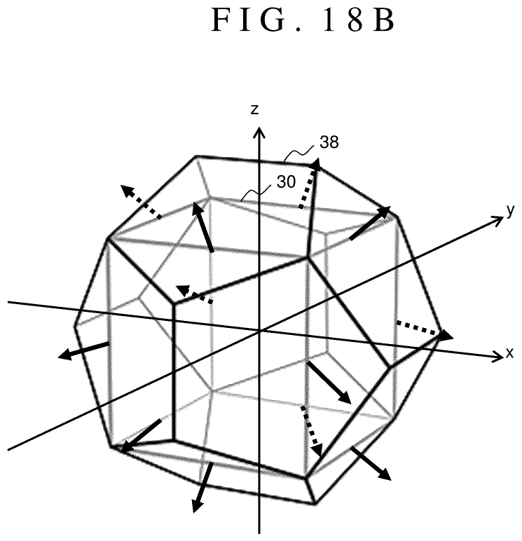

FIG. 18A and FIG. 18B are views for describing an example of the structure of another radio wave characteristic measurement device used by a wireless communication characteristic prediction system according to an embodiment.

As illustrated in FIG. 18A, secondary station units 31 are installed at 12 vertexes in a virtual cube 30 that has edges 2D and is installed in a three-dimensional Cartesian coordinate system, and a primary station unit 32 is installed at the center of gravity of the virtual cube 30.

The primary station unit 32 and each of the twelve secondary station units 31 are joined by a low-frequency cable 28 for transmitting digital signals.

Antennas mounted to the plurality of secondary station units 31 installed in the virtual cube 30 are installed at three-dimensionally equal intervals (√2D) with respect to the center of gravity of the virtual cube 30.

As illustrated in FIG. 18B, if a regular dodecahedron 38 circumscribing the virtual cube 30 is used, it is possible to install the 12 secondary station units 31 on the 12 faces of the regular dodecahedron 38, and thus the robustness of the structure of the radio wave characteristic measurement device is improved.

Because there are more relative phases for a radio wave received by each antenna which are uniformly distributed in three-dimensional space and the primary station unit can use these relative phases in order to determine a direction of arrival for the radio wave, improvement of the accuracy of calculating the direction of arrival is also realized.

By virtue of the present embodiment, with respect to the embodiment in FIG. 11, there is an effect of reducing prediction error for the direction of arrival of a received radio wave while also maintaining robustness for the radio wave characteristic measurement device.

### [Eighteenth Embodiment]

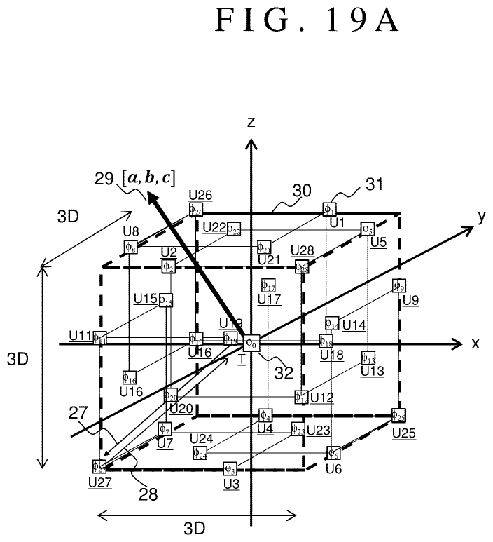

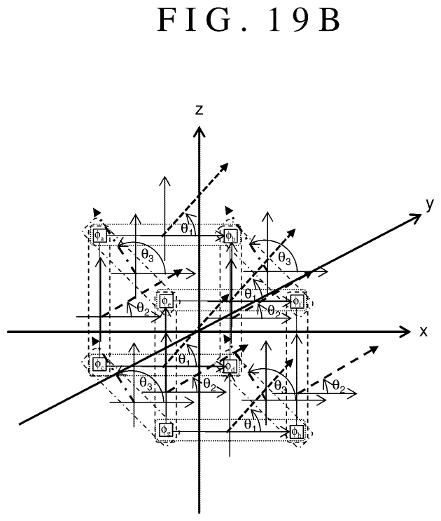

FIG. 19A and FIG. 19B are views for describing an example of the structure of another radio wave characteristic measurement device used by a wireless communication characteristic prediction system according to an embodiment.

As illustrated in FIG. 19A, squares having edges 2D and a similar shape to faces of a virtual cube 30 that has edges 3D and is installed in three-dimensional Cartesian coordinate system are inscribed in the faces of the virtual cube 30 having edges 3D and are set such that one vertex of two of the squares having edges 2D overlaps with a vertex of a diagonal for a face of the virtual cube 30 having edges 3D.

A secondary station unit 31 is installed at each vertex of these two squares having edges 2D. A total of eight secondary station units 31 are provided: two—one at each of the opposite vertexes on a face of the virtual cube 30 having edges 3D, plus four—one on each edge, plus two—there are two near the center of gravity of the face. Such a face is composed into a rectangular parallelepiped such that six secondary station units 31 positioned at vertexes and edges are shared, giving total of 28 secondary station units 31 that are installed on the rectangular parallelepiped.

FIG. 19A illustrates a state in which the primary station unit 32 is installed at the center of gravity of the virtual cube 30, and the secondary station units 31 are disposed on the surface of the virtual cube 30.

FIG. 19B is a view for describing an operation for causing attenuation of a received wave that arrives at a plurality of directions for eight secondary station units 31 disposed on one face of the virtual cube 30. In FIG. 19B, in two paired secondary station units 31, by adding together at opposite phases radio waves arriving from directions θ1 and θ2, which differ to each other, and direction θ3, it is possible to attenuate the power of the radio waves that arrive from the directions θ1, θ2, and θ3.

If this operation is performed for every two faces that are spatially orthogonal, even in a case where radio waves arriving at the movable radio wave measurement device 7 arrive from a maximum of four different directions, with respect to faces that are parallel to each other, it is possible to use 24 secondary station units from among the total of 28 secondary station units to calculate the respective direction of arrival with respect to these faces for a plurality incoming waves, and by performing similar processing with respect to three groups of all faces, it is possible to estimate the direction of arrival of a maximum of four radio waves that arrive at the movable radio wave measurement device 7 in three dimensions.

In this manner, secondary station units are disposed such that 2\hat{ }N isometric line segments parallel to each other and having N inclinations are formed one face of a regular hexahedron, and the phase of an incoming wave measured by each secondary station unit is used to estimate the direction of arrival of a maximum of N+1 radio waves by attenuating the power of radio waves having a specific direction of arrival. For example, one or more virtual squares are formed on one face of the regular hexahedron, and secondary station units are disposed at all vertexes of these virtual squares.

By virtue of the present embodiment, it is possible to increase the precision of a calculation model for estimating a radio wave environment in which a wireless communication system operates, and thus there is an effect of improving the accuracy of predicting communication performance for this wireless system.

### [Nineteenth Embodiment]

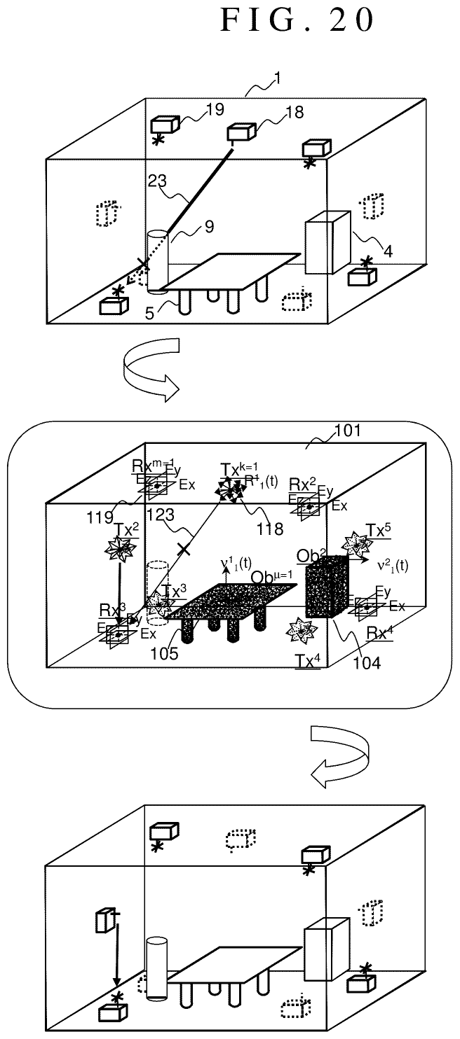

FIG. 20 is a view for describing an example of a configuration of an environment-adaptive wireless communication network that uses a wireless communication characteristic prediction system which is able to reduce the cost of implementing a wireless system for providing a communication service. Shelves 4 and a table 5 are disposed inside a room 1 that is to be a service area in which wireless communication is performed. A movable obstacle 9 such as a person or robot that moves inside this area is present. A plurality of primary stations 18 and a plurality of secondary stations 19 that wirelessly communicate with the primary stations 18 are installed on the floor, walls, and ceiling that construct this indoor space.

A calculation model for calculating an electromagnetic field within the service area is constructed within a computer resource, and the calculation model includes a polygon group 101 (display omitted) that represents the floor, ceiling, and walls, a polygon group 104 that represents the shelves 4, and a polygon group 105 that represents the table. A polygon group corresponding to the movable obstacle 9 is not included in the calculation model because a position for the movable obstacle cannot be identified in advance.

Transmission points 118 corresponding to the plurality of primary stations 18 and reception points 119 corresponding to the secondary stations are disposed in the computer resource. In a case where the quality of communication between a specific primary station and secondary station within the service area has deteriorated to less than or equal to a threshold defined in advance, a communication characteristic in accordance with a group of a transmission point and a reception point other than a group of the transmission point and reception point corresponding to the specific primary station and secondary station in the computer resource is calculated. The calculation model in the computer resource is used to search for a new primary station that indicates a good communication characteristic with respect to the secondary station. In a case where such a primary station is estimated, control is performed with respect to the corresponding primary station in real space to start communication with the secondary station that has been communicating at poor quality.

By virtue of the present embodiment, it is possible to, by adapting to deterioration of wireless communication quality arising in a service area, change a primary station that communicates with a relevant secondary station, and thus there is an effect of restoring communication quality for the secondary station, and an effect of improving communication reliability and throughput for a wireless network configured by a plurality of primary stations and secondary stations.

### [Twentieth Embodiment]

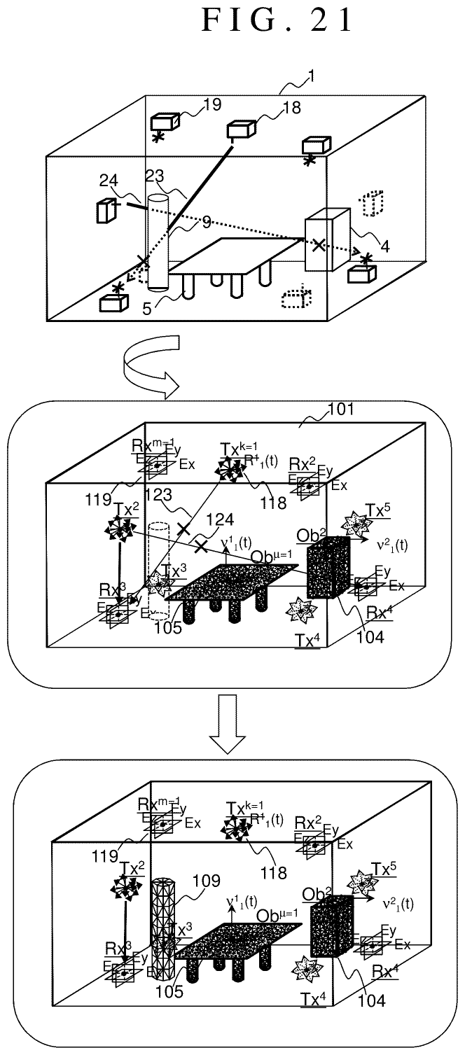

FIG. 21 is a view for describing an example of a configuration of another environment-adaptive wireless communication network that uses a wireless communication characteristic prediction system which is able to reduce the cost of implementing a wireless system for providing a communication service. Description is mainly given for differences from the example in FIG. 20.

In the present embodiment, a polygon group corresponding to the movable obstacle 9 is created separately, but is not disposed in advance in the calculation model.

Transmission points 118 corresponding to the plurality of primary stations 18 and reception points 119 corresponding to the secondary stations are disposed in the computer resource. In a case where the quality of communication between a specific primary station and secondary station within the service area has deteriorated to less than or equal to a threshold defined in advance, a communication characteristic for the corresponding transmission point and reception point in the computer resource is calculated. In a case where, in accordance with the communication quality obtained by calculation, the communication quality for a primary station and secondary station that are communicating in real space exceeds a tolerance value defined in advance and is deteriorating, it is determined that there is an obstacle with respect to radio waves between the corresponding transmission point and reception point in the computer resource, and a polygon group 109 that has been created in advance is virtually added between the transmission point and the reception point.

The polygon group 109 corresponding to the movable obstacle 9 is caused to move within a region that blocks a path joining the transmission point and the reception point in the calculation model, a calculated value for communication quality between the transmission point and the reception point is sequentially obtained, and the calculation model is changed by employing, as a virtual disposition point, the position of the polygon group 109 that imparts a calculated value for communication quality closest to the corresponding reception quality for the primary station and the secondary station in real space.

Using the changed calculation model, a primary station that can wirelessly communicate with the secondary station with good quality is estimated from the position of the transmission point in computer resource, and control is performed for the corresponding primary station and the secondary station communicate.

By virtue of the present embodiment, it is possible to, by adapting to dynamic deterioration of wireless communication quality arising in a service area, change a primary station that communicates with a relevant secondary station, and thus there is an effect of restoring communication quality for the secondary station in real-time and, in comparison to the embodiment in FIG. 20, there is an effect of further improving communication reliability and throughput for a wireless network configured by a plurality of primary stations and secondary stations.

By virtue of the embodiments described above, it is possible to use measurement data in a service area for providing wireless communication to construct a calculation model for an electromagnetic field by estimating, in a computer resource, communication quality within the service area. Accordingly, it is possible to generate an electromagnetic wave calculation model that can faithfully reproduce the actual radio wave environment at a site where wireless communication is performed, and it becomes possible to correct an electromagnetic field calculation model in the computer resource to promptly cope with environmental change for the wireless communication site. In addition, it becomes possible to improve the accuracy of estimating wireless communication performance within the wireless communication service area, and understanding communication performance in real time is realized. Furthermore, there is an effect of reducing the cost of wireless engineering necessary for customers to introduce a wireless communication system, because construction of an electromagnetic field calculation model that is constructed in a computer resource is possible on-site.

By virtue of the embodiments described above, it is possible to simulate a high-accuracy radio wave environment in a computer resource, and thus it is possible to reduce work in real space, and it is possible to contribute to lowering energy consumption, reducing carbon emissions, preventing global warming, and the realization of a sustainable society.

What is claimed is:

1. A radio environment evaluation method, comprising:
constructing, within a computer resource, a structural model for an electromagnetic wave scatterer, and when calculating a characteristic of an electromagnetic field by using the structural model and a ray that simulates a radio wave traveling straight through real space,
correcting, in accordance with electromagnetic wave vector measurement data for real space, a state of a polygon included in the structural model.

2. The radio environment evaluation method according to claim 1, wherein
the structural model is constructed by an aggregate of polygons having, as vertexes, a plurality of points in a point cloud generated from distance measurement data that includes a direction and a distance that are obtained at a plurality of locations in real space.

3. The radio environment evaluation method according to claim 1, wherein
a direction of a normal of the polygon is corrected.

4. The radio environment evaluation method according to claim 1, wherein
a state of the polygon is corrected by causing coordinates of a vertex belonging to the polygon to move.

5. The radio environment evaluation method according to claim 1, wherein
a location within the structural model, the location corresponding to a location where a difference between a measured electric field strength based on the electromagnetic wave vector measurement data and an estimated electric field strength calculated using the structural model is greater than or equal to a predetermined value, is identified as an abnormal location, and
a state is corrected by setting a polygon facing the abnormal location as a polygon requiring correction.

6. The radio environment evaluation method according to claim 5, wherein
the polygon requiring correction is determined on a basis of a direction of arrival of a received wave measured at a location in real space, the location corresponding to the abnormal location.

7. The radio environment evaluation method according to claim 5, wherein,
when correcting a state of the polygon requiring correction, polygons sharing a vertex with the polygon requiring correction are identified as alternative candidate polygons,
in a case where the estimated electric field strength is less than the measured electric field strength by a predetermined value or more at the abnormal location, from among the alternative candidate polygons, an alternative candidate polygon for which a colliding ray has an intensity greater than a ray colliding with the polygon requiring correction is selected, and the polygon requiring correction and the alternative candidate polygons are corrected such that the ray colliding with the selected alternative candidate polygon faces the abnormal location, and
in a case where the estimated electric field strength is greater than the measured electric field strength by a predetermined value or more at the abnormal location, from among the alternative candidate polygons, an alternative candidate polygon for which a colliding ray has an intensity less than a ray colliding with the polygon requiring correction is selected, and the polygon requiring correction and the alternative candidate polygons are corrected such that the ray colliding with the selected alternative candidate polygon faces the abnormal location.

8. The radio environment evaluation method according to claim 6, wherein
the direction of arrival of the received wave is measured using information regarding a relative phase for the received wave received by a plurality of antennas distributed in three-dimensional space, and regarding spatial positions for the antennas.

9. The radio environment evaluation method according to claim 8, wherein
a group of two antennas that are uniformly distributed in three-dimensional space and are in an orthogonal relationship with respect to each other spatially is used to measure the direction of arrival and polarization for the received wave.

10. The radio environment evaluation method according to claim 8, wherein
the direction of arrival of the received wave is measured using antennas installed on each face of a virtual regular hexahedron, a regular octahedron, or a regular dodecahedron.

11. A wireless communication characteristic evaluation system, comprising:
a model generation unit; an electric field calculation unit; and a polygon correction unit, wherein
the model generation unit constructs, in a computer resource, a structural model for an electromagnetic wave scatterer present in real space,
the electric field calculation unit uses the structural model to perform a ray-tracing calculation, estimates an electric field strength within real space, and calculates an estimated electric field strength, and
the polygon correction unit, on a basis of a direction of arrival of an electromagnetic wave measured within real space, identifies and corrects a polygon needing correction from among polygons included in the structural model.

12. The wireless communication characteristic evaluation system according to claim 11, further comprising:
an error detection unit, wherein
the error detection unit extracts, as an abnormal location, a location where a difference between a measured electric field strength that is measured in real space and the estimated electric field strength is greater than or equal to a predetermined value, and
the polygon correction unit, on a basis of a direction of arrival of an electromagnetic wave measured at a location in real space, the location corresponding to the abnormal location, identifies the polygon needing correction.

13. The wireless communication characteristic evaluation system according to claim 11, wherein
the polygon correction unit performs correction by changing coordinates for a vertex in a polygon.

14. The wireless communication characteristic evaluation system according to claim 11, wherein
the polygon correction unit performs correction by changing a normal for a polygon.

15. The wireless communication characteristic evaluation system according to claim 12, wherein
the polygon correction unit
identifies polygons adjacent to a polygon that is in the direction of arrival of the electromagnetic wave measured at the location in real space, the location corresponding to the abnormal location,
in a case where the estimated electric field strength is less than the measured electric field strength by a predetermined value or more at the abnormal location, selects, from among the identified polygons, a polygon for which a colliding ray has an intensity greater than a ray colliding with the polygon in the direction of arrival for the electromagnetic wave, and corrects the polygons such that the ray colliding with the selected polygon faces the abnormal location, and
in a case where the estimated electric field strength is greater than the measured electric field strength by a predetermined value or more at the abnormal location, selects, from among the identified polygons, a polygon for which a colliding ray has an intensity less than a ray colliding with the polygon in the direction of arrival for the electromagnetic wave, and corrects the polygons such that the ray colliding with the selected polygon faces the abnormal location.
